(19) United States
(12) Patent Application Publication
(10) Pub. No.: US 2006/0222869 A1
(43) Pub. Date: Oct. 5, 2006

(54) Electropen lithography

(76) Inventors: Yuguang Cai, Patchogue, NY (US); Benjamin M. Ocko, Stony Brook, NY (US)

Correspondence Address: BROOKHAVEN SCIENCE ASSOCIATES/;BROOKHAVEN NATIONAL LABORATORY, BLDG. 475D - P.O. BOX 5000, UPTON, NY, 11973, US

(21) Appl. No.: 11/097,917

(22) Filed: Apr. 4, 2005

(51) Int. Cl. B32B 27/00; B32B 9/04; C23C 26/00

(52) U.S. Cl. 428/447; 427/256

(57) ABSTRACT

The present invention relates to methods for producing a patterned surface having nanoscale features. The present invention more particularly relates to tip-induced nanoelectrochemical oxidation methods for nanoscale patterning. The invention also relates to the nanoscale patterns produced thereby.

This invention was made with Government support under contract number DE-AC02-98CH10886, awarded by the U.S. Department of Energy. The Government has certain rights in the invention.

### BACKGROUND OF THE INVENTION

The present invention relates to methods for producing a patterned surface having nanoscale features, and in particular, to novel scanning probe nanolithography techniques for producing such patterned surfaces.

There is a need in many diverse technologies for providing complex structures and patterns on the nanoscale level, and especially on the molecular level. For example, nanoscale structures and patterns are of great importance in the fabrication of advanced electronic, photonic, and sensing devices, among others.

However, producing nanoscale patterns presents a significant challenge. For example, conventional “top down” methods such as photon, electron, and ion methods, have been relied upon to produce ever smaller patterns. However, these methods have serious limitations in producing nanoscale patterns, especially when approaching the molecular level.

Another approach which has been receiving considerable attention for creating such nanoscale patterns is the “bottom up” approach. For example, one popular approach has been to adapt the well known imaging techniques of scanning probe microscopy (SPM) to manipulating atoms and molecules. Such methods are known as scanning probe lithography (SPL) techniques. SPL makes use of such SPM techniques as, for example, atomic force microscopy (AFM) and scanning tunneling microscopy (STM), to precisely and selectively place individual molecules in specific locations.

For example, SPL has been used to nanograft molecules in a self-assembled monolayer (SAM). In conventional nanografting techniques, SAM molecules are selectively removed by the scanning probe tip. The resulting void is then filled with other molecules, also known as ink molecules or patterning molecules. Some of the most significant drawbacks of the nanografting technique are its slow speed and the dependence on the size of the tip.

Another widely used SPL technique is dip-pen lithography. In dip-pen lithography, the scanning probe tip functions similarly to a fountain pen, but on a molecular level. When the ink-coated tip is in contact with a suitable surface, the ink molecules on the tip are transferred from the tip to the surface.

One significant drawback of dip-pen lithography is its slow speed due to the requirement of the tip to continuously withdraw from writing in order to replenish the tip with ink. Another significant drawback of dip-pen lithography is that characterization of features thus fabricated is a difficult and inconvenient process. For example, when using the same tip in situ, very fast scan speeds would be required in order to image while minimizing ink delivery. Such fast scan speeds, especially after numerous repetitions, destroy the pattern. When a separate tip is used for imaging, specific features of the pattern must again be located, thus presenting a time consuming and difficult task.

Most recently, it has been found that patterns can be made on SAMs by applying a voltage to an AFM tip when the tip is in contact with certain molecular groups of the SAM. For example, it has recently been shown that methyl-terminated and vinyl-terminated SAM molecules can be selectively oxidized to carboxylic acid groups via tip-induced nanoelectrochemical oxidation. The carboxylic-terminated molecules that form the pattern are then reacted in solution with ink molecules that contain functional groups reactive to carboxylic acid groups. See, for example, R. Maoz, et al., Advanced Materials, 12 (10), pp. 725-731 (2000); R. Maoz, et al., Advanced Materials, 11 (1), pp. 55-61 (1999); S. Hoeppener, et al., Advanced Materials, 14 (15), pp. 1036-1041 (2002).

However, due to the required dipping of the substrate into a solution of ink molecules, the conventional tip-induced nanoelectrochemical oxidation methods discussed above share the same drawbacks noted above. For example, after the solution dipping step, any features thus fabricated cannot be characterized or imaged using the same tip in-situ. Thus, locating and characterizing specific features of the pattern is a time consuming and difficult task.

Accordingly, there is a need for a method that provides the benefits of tip-induced nanoelectrochemical oxidation, and that does not have the drawbacks discussed above. In this regard, none of the art discussed above disclose a patterning method based on tip-induced nanoelectrochemical oxidation, wherein the tip performs the oxidation and simultaneously provides the ink to react with the resulting oxidized species. The present invention relates to such methods and patterned surfaces produced thereby.

### SUMMARY OF THE INVENTION

In one aspect, the present invention relates to a method for producing a nanoscale patterned surface. The method includes: providing an ultrafine tip having a first group of patterning molecules provided thereon; providing a substrate surface having oxidizable groups accessible to the ultrafine tip; contacting the ultrafine tip with a selected portion of the substrate surface; positioning the ultrafine tip to be sufficiently proximal to the substrate surface in the presence of a liquid transporting medium to form a meniscus between the ultrafine tip and the substrate surface; applying to the ultrafine tip a negative voltage capable of oxidizing the oxidizable groups to an oxidized form; whereby the substrate surface and the ultrafine tip are at least partially electrically conductive; and the first group of patterning molecules are capable of being hydrolyzed by, and/or capable of reacting with, the oxidized form, thereby producing a nanoscale surface patterned with a first group of patterning molecules.

Preferably, the substrate surface is at least partially covered with substrate surface molecules. Preferably, at least a portion of the substrate surface molecules include methyl, vinyl, acetylenyl, or mercapto groups, or a combination thereof. More preferably, at least a portion of the substrate surface molecules are terminated with one or more methyl, vinyl, acetylenyl groups, mercapto groups, or a combination thereof.

The substrate surface can be chemically the same, or different from, the bulk substrate. For example, the bulk substrate and/or the substrate surface can be independently selected from a metal, metal alloy, metal oxide, metal sulfide, metal selenide, metal telluride, metal nitride, metal phosphide, metal arsenide, metal boride, metal carbide, metal silicide, metal salt, superconducting material, conducting polymer, or a combination thereof.

Some examples of metals suitable as substrate surfaces and/or bulk substrates include copper, nickel, aluminum, n- or p-doped silicon, gold, silver, palladium, platinum, rhodium, iridium, titanium, graphite, zinc, iron, beryllium, magnesium, or calcium. Some examples of metal oxides include n- or p-doped silicon oxide, mica, indium tin oxide, titanium oxide, iron oxide, copper oxide, yittrium oxide, zirconium oxide, thallium oxide, lithium oxide, magnesium oxide, calcium oxide, and aluminum oxide. Some examples of metal sulfides include cadmium sulfide, gallium sulfide, iron sulfide, nickel sulfide, copper sulfide, lead sulfide, and zinc sulfide. Some examples of metal selenides include cadmium selenide, gallium selenide, copper selenide, and zinc selenide.

Some examples of metal nitrides suitable as substrate surfaces and/or bulk substrates include gallium nitride, indium nitride, aluminum nitride, and boron nitride. Some examples of metal phosphides include gallium phosphide, indium phosphide, and zinc phosphide. Some examples of metal arsenides include gallium arsenide, indium arsenide, and zinc arsenide.

Some examples of metal carbides suitable as substrate surfaces and/or bulk substrates include tungsten carbide, silicon carbide, molybdenum carbide, titanium carbide, aluminum carbide, vanadium carbide, boron carbide, lithium carbide, barium carbide, calcium carbide, and tantalum carbide.

Some examples of metal salts suitable as substrate surfaces and/or bulk substrates include the metal salts derived from one or more alkali or alkaline earth metal ions in combination with one or more counteranions selected from halide, sulfate, nitrate, phosphate, carboxylate, borate, carbonate, silicate, selenoate, and arsenate.

Some examples of conducting polymers suitable as substrate surfaces and/or bulk substrates include polyaniline, polypyrrole, polythiophene, poly(para-phenylene), poly(p phenylenevinylene), polyacetylene, and combinations thereof, chemical derivatives thereof, and doped derivatives thereof.

When the oxidizable group is methyl, vinyl, or acetylenyl, the oxidized form is preferably a carboxylic acid group. When the oxidizable group is a mercapto group, the oxidized form is preferably a sulfonic acid group.

In a preferred embodiment, the ultrafine tip is a scanning probe microscopy tip. The surface of the tip is typically composed of a metal, metal alloy, or semiconductor material. More preferably, the ultrafine tip has a surface which includes doped silicon, silicon nitride, tungsten, tungsten carbide, diamond-coated silicon, metal-coated silicon, or metal-coated silicon nitride. Some examples of metal-coated silicon nitride tips include platinum-coated silicon nitride, titanium-coated silicon nitride, copper-coated silicon nitride, and silver-coated silicon nitride.

In a preferred embodiment, at least a portion of the substrate surface molecules are independently saturated or unsaturated; straight-chained or branched; cyclic, polycyclic, fused ring, or acyclic hydrocarbon molecules having 1 to 50 carbon atoms. Optionally, one or more carbon atoms of the hydrocarbon molecules are substituted by one or more heteroatom linkers or heteroatom groups. Alternatively, or in addition, one or more hydrogen atoms of the hydrocarbon molecules are substituted by one or more heteroatom groups.

In a further preferred embodiment, at least a portion of the substrate surface hydrocarbon molecules described above are substituted by one or more silano groups. A silano group is any group containing one or more silicon (Si) atoms. Some preferred examples of silano groups include —Si(R⁷)₃, —Si(R⁷)₂—, —Si(R⁷)═, —Si≡, —SiCl₃, —SiCl₂—, —SiCl═, —Si(O—)₃, —Si(O—)₂—, —Si(O—)═, —Si(OR⁷)₃, —SiR⁷(OR⁷)₂, and —Si(R⁷)₂(OR⁷). In the examples of silano groups, the symbols ═ and ≡ represent two and three separate single bonds, respectively, wherein each single bond is between a silicon atom and a carbon atom or suitable heteroatom. Preferably, R⁷ independently represents H, or a saturated or unsaturated; straight-chained or branched; cyclic or acyclic hydrocarbon group having 1 to 6 carbon atoms.

In a further preferred embodiment, at least a portion of the substrate surface molecules containing one or more silano groups are surface siloxane molecules. Preferably, the surface siloxane molecules are represented by the formula:
R¹ₙR²ₘR³ₚSi(OR⁴)₄₋ₘ₋ₙ₋ₚ (1)

In formula (1), R¹, R², and R³ preferably independently represent H; or saturated or unsaturated; straight-chained or branched; cyclic, polycyclic, fused ring, or acyclic hydrocarbon groups having 1 to 50 carbon atoms. Optionally, one or more carbon atoms of the hydrocarbon groups of R¹, R², and R³ are substituted by one or more heteroatom linkers or heteroatom groups. Alternatively, or in addition, one or more hydrogen atoms of the hydrocarbon groups of R¹, R², and R³ are substituted by one or more heteroatom groups. R⁴ preferably independently represents H; or a saturated or unsaturated, straight-chained or branched, cyclic or acyclic hydrocarbon group having 1 to 6 carbon atoms; or a silano group.

In formula (1), at least a portion of the hydrocarbon groups of R¹, R², and R³ are terminated with methyl, vinyl, acetylenyl, or mercapto groups, or a combination thereof. The subscripts m, n, and p independently represent 0 or 1, provided that at least one of m, n, and p is 1 and at least one of R¹, R², and R³ groups represents the hydrocarbon groups of R¹, R², and R³; or, when m, n, and p are all 0, then R⁴ represents the hydrocarbon groups of R⁴, wherein at least a portion of the hydrocarbon groups of R⁴ are terminated with methyl, vinyl, acetylenyl, or mercapto groups, or a combination thereof.

In a further preferred embodiment to formula (1), the surface siloxane molecules are represented by the formula:
R¹Si(OR⁴)₃ (3)

In formula (3), R¹ preferably represents a saturated or unsaturated; straight-chained or branched; cyclic, polycyclic, fused ring, or acyclic hydrocarbon group having 1 to 50 carbon atoms. R⁴ is preferably as defined above.

In one embodiment, the OR⁴ groups in formulas (1) or (3) are not involved in a hydrolysis reaction. In another embodiment, the OR⁴ groups are hydrolyzed in the presence of surface-adsorbed water to form crosslinked surface siloxane molecules. The crosslinked surface siloxane molecules have intermolecular silicon-oxide-silicon bonds and/or silicon-oxide-metal bonds between the surface siloxane molecules and the metal of a metal oxide surface.

More preferably, the crosslinked surface siloxane molecules described above are formed by surface-mediated hydrolysis of the corresponding chlorosilane precursors. An example of a class of such chlorosilane precursors includes the formula:
R¹ₙR²ₘR³ₚSiCl₄₋ₘ₋ₙ₋ₚ (2)

In formula (2), R¹, R², and R³ are as defined in formula (1) above. The subscripts m, n, and p independently represent 0 or 1, provided that at least one of m, n, and p is not 0, and at least one of R¹, R², and R³ is not H.

In a further preferred embodiment to formula (2), the crosslinked surface siloxane molecules are formed by surface-mediated hydrolysis of trichlorosilane precursors of the formula:
R¹SiCl₃ (4)

In formula (4), R¹ preferably represents a saturated or unsaturated, straight-chained or branched, cyclic, polycyclic, fused ring, or acyclic hydrocarbon group having 1 to 50 carbon atoms.

In a further preferred embodiment of formula (4), R¹ is represented by the formula CH₃(CH₂)ₙ—, wherein s represents 0, or an integer from 1 to 30. More preferably, s represents an integer from 10 to 20. Even more preferably, s is approximately 17.

Some examples of trichlorosilane precursors according to formula (4) include methyltrichlorosilane, ethyltrichlorosilane, n-propyltrichlorosilane, iso-propyltrichlorosilane, n-butyltrichlorosilane, iso-butyltrichlorosilane, t-butyltrichlorosilane, n-pentyltrichlorosilane, n-hexyltrichlorosilane, n-heptyltrichlorosilane, n-octyltrichlorosilane, n-nonyltrichlorosilane, n-decyltrichlorosilane, n-undecyltrichlorosilane, n-hexadecyltrichlorosilane, n-octadecyltrichlorosilane, n-docosyltrichlorosilane, n-triacontyltrichlorsilane, 18-nonadecenyltrichlorosilane, (3-acryloxypropyl)-trichlorosilane, allyltrichlorosilane, 3-butenyltrichlorosilane, methacryloxypropyltrichlorosilane, 7-octenyltrichlorosilane, 10-undecenyltrichlorosilane, and vinyltrichlorosilane.

Preferably, the substrate surface molecules are capable of forming a positive interaction with the substrate surface and/or intermolecular bonds between the substrate surface molecules. The interactions or bonds can be independently covalent or non-covalent in nature. By forming these positive interactions or bonds, an ordered layer, e.g., a molecular monolayer, of the substrate surface molecules on the substrate surface is possible. Even more preferably, such interactions and/or bonds are capable of forming a self-assembled monolayer of the substrate surface molecules on the substrate surface.

In a preferred embodiment, the first group of patterning molecules are selected from the metal alkoxide, metal amide, amino, phosphino, arsino, alcohol, and epoxide classes of molecules. More preferably, the first group of patterning molecules are selected from one or a suitable combination of metal alkoxides.

Metal alkoxides suitable as patterning molecules are preferably alkoxides of one or a suitable combination of alkaline earth, transition metal, main group metal, lanthanide, or actinide classes of metals. More preferably, the metal alkoxides are alkoxides of the main group metals. Even more preferably, the main group metal in the metal alkoxide is silicon, thereby resulting in siloxane patterning molecules.

In a preferred embodiment, siloxane patterning molecules are represented by the formula:
R⁵_{q}R⁶ᵣSi(OR⁴)_{4-q-r} (5)

In formula (5), R⁵ and R⁶ independently represent H; halo; or saturated or unsaturated straight-chained or branched; cyclic, polycyclic, fused ring, or acyclic hydrocarbon groups having 1 to 50 carbon atoms. Optionally, one or more carbon atoms of the hydrocarbon groups of R⁵ and R⁶ are substituted by one or more heteroatom linkers or heteroatom groups. Alternatively, or in addition, one or more hydrogen atoms of the hydrocarbon groups of R⁵ and R⁶ are substituted by one or more heteroatom groups. In addition, the hydrocarbon groups of R⁵ and R⁶ are optionally connected to form a ring having three to six ring carbon atoms.

R⁴ in formula (5) independently represents H; or a saturated or unsaturated; straight-chained or branched; cyclic or acyclic hydrocarbon group having 1 to 6 carbon atoms; or a silano group. The subscripts q and r independently represent 0 or 1.

In a further embodiment of formula (5), at least a portion of the siloxane patterning molecules are represented by the formula:
R⁵Si(OR⁴)₃ (6)

In formula (6), R⁴ and R⁵ are as defined above in formula (5). More preferably, R⁵ is represented by the formula Yₐ—(CH₃₋ₐ)ₜ—, wherein Yₐ represents one or more functional groups; a represents 0, or an integer from 1 to 3; and t represents an integer from 1 to 50. More preferably, t represents an integer from 1 to 24. Even more preferably, t represents an integer from 1 to 10.

Some examples of suitable functional groups for Yₐ include, independently: halo, —CH₃, silano, —OR⁷, —SR⁷, —SeR⁷, —TeR⁷, —S—SR⁷, —N(R⁷)₂, —N(R⁷)₃+, —N₃, —NO₂, —C(O)N(R⁷)₂, —C(O)R⁷, —C(O)O—, —C(O)OR⁷, —C(S)OR⁷, —NR⁷C(O)OR⁷, —NR⁷—N(R⁷)₂, —NR⁷C(O)NR⁷, —N═N(R⁷), ═N—N(R⁷)₂, —OCN, —NCO, —SCN, —NCS, —P(R⁷)₂, —P(OR⁷)₂, —As(R⁷)₂, —CN, —NC, —S(O)₂OH, —SO₃⁻, —P(O)(OH)₂, —PO₃²⁻, —C(O)—O—C(O)R⁷, CR⁷═C(R⁷)₂, —C≡C—R⁷, maleimido, and biotinyl groups.

In the functional groups given above, R⁷ preferably represents H; or a saturated or unsaturated; straight-chained or branched; cyclic or acyclic hydrocarbon group having 1 to 6 carbon atoms. Optionally, R⁷ in —C(O)OR⁷ is an ester-activating group.

In one embodiment, Yₐ represents —SH and a is 1. Some examples of siloxane patterning molecules containing the —SH group include 3-mercaptopropyltrimethoxysilane, 3-mercaptopropyltriethoxysilane, or a combination thereof.

In another embodiment, Yₐ represents —NH₂ and a is 1. Some examples of siloxane patterning molecules containing the —NH₂ group include 3-aminopropyltrimethoxysilane, 3-aminopropyltriethoxysilane, or a combination thereof.

In another embodiment, Yₐ represents —CH═CH₂ and a is 1. Some examples of siloxane patterning molecules containing the —CH═CH₂ group include 18-nonadecenyltrimethoxysilane, 18-nonadecenyltriethoxysilane, allyltrimethoxysilane, allyltrimethoxysilane, allyltris(trimethylsiloxy)silane, 3-butenyltriethoxysilane, 21-docosenyltriethoxysilane, 10-undecenyltrimethoxysilane, vinyltriethoxysilane, vinyltrimethoxysilane, vinyltriisopropoxysilane, vinyltriisopropenoxysilane, vinyltriphenoxysilane, 7-octenyltrimethoxysilane, or any suitable combination thereof.

Preferably, the negative voltage bias applied on the tip is a minimum of approximately 5 volts. The maximum negative voltage bias can be, for example, approximately 15 volts.

Preferably, the liquid transporting medium is aqueous. The aqueous transporting medium can be composed of strictly water, or alternatively, a mixture of a non-aqueous solvent and water. In the mixture, the water can be in a trace amount. The non-aqueous solvent can be, for example, a protic, polar aprotic, or hydrocarbon solvent.

An example of a protic solvent includes the class of alcohol solvents, such as methanol, ethanol and isopropanol. Some examples of polar aprotic solvents include acetonitrile, dimethylsulfoxide, methylene chloride, chloroform, ether-containing solvents, ester-containing solvents, and amide-containing solvents. Some examples of hydrocarbon solvents include the pentanes, hexanes, heptanes, octanes, benzene, toluene, and xylenes.

An aqueous transporting medium preferably results from performing at least some portion of the method under conditions of non-zero humidity. Preferably, the humidity is a minimum of about fifty percent to a maximum of about one hundred percent. More preferably, the humidity is approximately one hundred percent.

A further embodiment to the method includes imaging the patterned surface using any of the suitable images techniques known in the art. Preferably, the pattern is imaged using a scanning probe microscopy imaging technique. Even more preferably, the pattern is imaged using the same ultrafine tip which was used for patterning.

Another further embodiment to the method includes producing one or more additional patterns on top of the first group of patterning molecules which have been patterned on the substrate surface. For example, the method can further include: contacting an ultrafine tip having a second group of patterning molecules provided thereon with a selected portion of a substrate surface having a first group of patterning molecules having oxidizable groups accessible to the ultrafine tip; positioning the ultrafine tip to be sufficiently proximal to the substrate surface in the presence of a liquid transporting medium to form a meniscus between the ultrafine tip and the substrate surface; applying to the ultrafine tip a negative voltage capable of oxidizing the oxidizable groups to an oxidized form; whereby the second group of patterning molecules are capable of being hydrolyzed by, and/or capable of reacting with, the oxidized form, thereby producing a surface patterned with a second group of patterning molecules. The process, as described above, can be optionally repeated using any number of subsequent groups of patterning molecules to produce a surface patterned with the same number of subsequent groups of patterning molecules.

In another aspect, the invention relates to a nanoscale patterned surface produced by any of the methods described above. For example, a silicon oxide nanoscale patterned surface can be produced by a method comprising: providing an ultrafine tip having a first group of siloxane patterning molecules provided thereon; providing a silicon oxide surface at least partially covered with siloxane molecules terminated with methyl, vinyl, acetylenyl, or mercapto groups, or a combination thereof; contacting the ultrafine tip with a selected portion of the silicon oxide surface; positioning the ultrafine tip to be sufficiently proximal to the silicon oxide surface in the presence of a liquid transporting medium to form a meniscus between the ultrafine tip and the silicon oxide surface; applying to the ultrafine tip a negative voltage capable of oxidizing the methyl, vinyl, acetylenyl, or mercapto groups to an oxidized form; whereby the silicon oxide surface and the ultrafine tip are at least partially electrically conductive; and the first group of siloxane patterning molecules are capable of being hydrolyzed by, and/or capable of reacting with, the oxidized form.

In the present invention, the ultrafine tip simultaneously performs the oxidation and provides the patterning molecules required to react with the resulting oxidized species. Accordingly, the invention advantageously provides the benefits of tip-induced nanoelectrochemical oxidation for nanoscale patterning, while not having the drawback of using solution methods for providing the patterning molecules.

### BRIEF DESCRIPTION OF THE FIGURES

FIG. 1. The principle of electropen lithography. In a humid environment, by applying a voltage across the conducting AFM tip and octadecyltrichlorosilane (OTS) film, the OTS film is converted to reactive COOH terminated surface (OTSₒₓ). The ink pre-coated on the tip is delivered onto the reactive OTSₒₓ surface and forms a second layer.

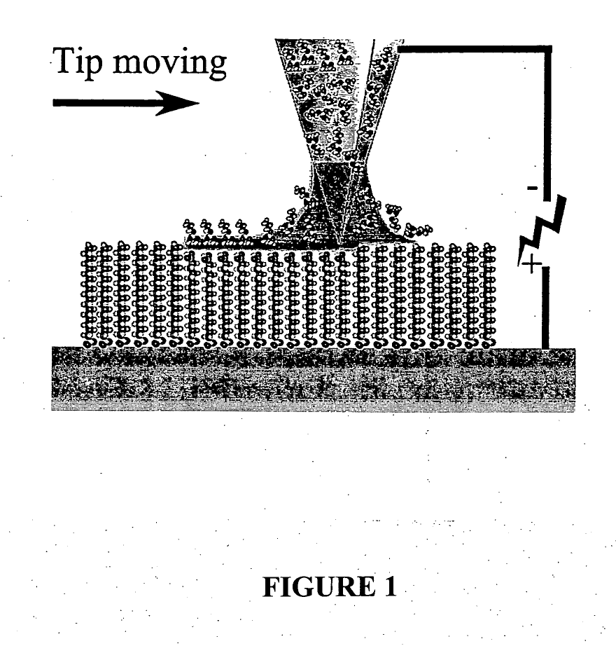

FIG. 2. Patterns written using electropen lithography on OTS surface with mercaptopropyltrimethoxysilane (MPTMS) ink.

FIG. 3. Electropen lithography has multilayer writing capability.

FIG. 4. Fabricating a patterned surface with two different chemistries.

### DETAILED DESCRIPTION OF THE INVENTION

In one aspect, the invention relates to a method for producing a patterned surface. The invention is most suited for producing patterns having nanoscale features, i.e., nanoscale patterns. The features of the pattern can consist of, for example, dots, lines, arcs, complex shapes, and any interconnections between them.

The features of such nanoscale patterns can be as large as several hundreds of nanometers (nm). For example, a line can be written having a width of approximately 500 nm, 400 nm, 300 nm, 200 mm, or 100 nm. The features of such nanoscale patterns can be as small as a few nanometers. For example, a line can be traced having a width of 50 nm, 25 nm, 20 nm, 15 nm, 10 nm, or 5 nm. The features of such nanoscale patterns can even be on the scale of one or several molecules.

However, the overall pattern itself can be of any desired dimension. For example, the overall pattern can be on the scale of a few nanometers, a few hundred nanometers, a micron, a few microns, tens of microns, hundreds of microns, a millimeter, a few millimeters, tens of millimeters, hundreds of millimeters, or even on the centimeter scale.

The invention uses a very sharp tip, i.e., an ultrafine tip, for patterning a surface. The ultrafine tip has a very small apex radius of nanometer dimension. For example, the ultrafine tip can have an apex radius of 50 nm, 40 nm, or 30 nm. More preferably, the ultrafine tip has an apex radius of 20 nm or lower.

In a preferred embodiment, the ultrafine tip is a scanning probe microscopy (SPM) tip. The SPM tip can be any tip used in any of the scanning probe microscopy techniques, as long as the tip is at least partially electrically conductive. For example, the tip can be any conductive tip used in atomic force microscopy (AFM), scanning tunneling microscopy (STM), scanning electrochemical microscopy (SECM), or near-field optical microscopy (NSOM). Numerous kinds of SPM tips are commercially available.

Since the invention requires the use of a voltage applied to the ultrafine tip, the tip or at least the tip surface must be at least partially electrically conductive. The tip surface is also preferably made of a material which does not react with, or covalently bond to, the patterning molecules on the tip surface in the time scale of the patterning process.

For example, the tip can be made of, or include, a metal, metal alloy, or semiconductor material. Some examples of suitable metals for the tip include, where appropriate, tungsten, chromium, copper, nickel, aluminum, gold, silver, palladium, platinum, rhodium, iridium, titanium, graphite, and zinc. Some examples of suitable metal alloy materials for the tip include, where appropriate, silicon nitride and tungsten carbide. An example of a suitable semiconductor material for the tip includes doped silicon, i.e., n-doped or p-doped silicon.

The ultrafine tip may additionally be coated with another suitable material, where appropriate. Some examples of coated tips include diamond-coated silicon, metal-coated silicon, and metal-coated silicon nitride. The metals in the tip coating can be any of the metals previously noted above. Some examples of metal-coated silicon tips include platinum-coated silicon and titanium-coated silicon tips. Some examples of metal-coated silicon nitride tips include platinum-coated silicon nitride, titanium-coated silicon nitride, copper-coated silicon nitride, or silver-coated silicon nitride tips.

The ultrafine tip can be coated by any of the techniques known in the art. For example, the tip can be coated using solution or vapor deposition techniques.

The ultrafine tip is contacted with a substrate surface in a carefully controlled and precise manner. Preferably, the tip is contacted with the substrate surface using any of the scanning probe microscopy techniques known in the art.

The ultrafine tip is positioned sufficiently proximal to the substrate surface such that a meniscus of a liquid transporting medium between the substrate surface and the tip is formed. A sufficiently proximal distance from the tip to the substrate surface can be, for example, in the nanometer, sub-nanometer, Angstrom, and sub-Angstrom ranges. Such minute distances are preferably realized by using scanning probe microscopy techniques.

The liquid transporting medium interconnects the ultrafine tip and substrate surface, thereby allowing the patterning molecules on the tip to be transported to the substrate surface. The tip is “in contact” with the substrate surface when it is close enough to form such a meniscus.

The liquid transporting medium can be any suitable liquid. For example, the liquid transporting medium can be an aqueous or non-aqueous solvent. Some examples of aqueous solvents include water and mixtures of water and another solvent. Some examples of non-aqueous solvents include protic solvents, polar aprotic solvents, and hydrocarbon solvents.

Some examples of non-aqueous protic solvents include alcohols. Some examples of alcohols include methanol, ethanol, n-propanol, iso-propanol, n-butanol, pentanol, and the like.

Some examples of polar aprotic solvents include acetonitrile, dimethylsulfoxide, methylene chloride, chloroform, ether-containing solvents, ester-containing solvents, and amide-containing solvents. Some examples of ether-containing solvents include diethyl ether and diisopropyl ether. An example of an ester-containing solvent includes ethyl acetate. Some examples of amide-containing solvents include dimethylformamide and dimethylacetamide.

Some examples of hydrocarbon solvents include pentanes, hexanes, heptanes, octanes, benzene, toluene, and xylenes.

Preferably, the liquid transporting medium is any liquid medium that contains water. More preferably, the liquid transporting medium is completely water, i.e., an aqueous transporting medium. If desired, the aqueous transporting medium may further include, for example, one or more salts, buffering agents, acids, bases, wetting agents, or metal complexing agents.

The aqueous transporting medium preferably results from performing at least some portion of the method under conditions of non-zero humidity. The level of humidity can be any desired or suitable level of humidity. Preferably, the humidity is a minimum of about fifty percent. More preferably, the humidity level is between about fifty percent and about one hundred percent. Even more preferably, the humidity level is approximately one hundred percent.

The transporting medium can also be a mixture of any of the non-aqueous solvents described above and water. For example, the water can be present in a trace amount in any of the non-aqueous solvents described above.

When a non-aqueous solvent is used, the vapor pressure of the solvent is controlled. The vapor pressure of the solvent is any vapor pressure considered appropriate or suitable for the patterning process.

For the purposes of this invention, the substrate surface needs to be at least partially electrically conductive in order for a negative voltage to induce a current between the substrate surface and the tip. Hence, the substrate surface can be made of essentially any material which is at least partially electrically conductive, i.e., not completely insulating.

Where appropriate, the substrate surfaces can be suitably doped. Such doping can render relatively non-conductive materials at least partially electrically conductive.

In one embodiment, the substrate surface is a metal. Some examples of classes of metals suitable as a substrate surface include the alkali, alkaline earth, main group, transition, lanthanide, and actinide classes of metals. Some more specific examples of metals suitable as a substrate surface include copper, nickel, aluminum, n- or p-doped silicon, gold, silver, palladium, platinum, rhodium, iridium, titanium, graphite, zinc, iron, beryllium, magnesium, or calcium.

In another embodiment, the substrate surface is a metal alloy. Metal alloys include a combination of two or more metals, and hence, include binary, ternary, quaternary, and higher alloys. The metals in such a metal alloy can be a combination of, for example, any of the metals described above. Such a combination can include, for example, two or more transition metals, or one or more transition metals with one or more main group and/or alkaline earth metals.

For example, the substrate surface can be a metal oxide. Some examples of metal oxides suitable as substrate surfaces include n- or p-doped silicon oxide, mica, indium tin oxide, titanium oxide, iron oxide, copper oxide, yittrium oxide, zirconium oxide, thallium oxide, lithium oxide, magnesium oxide, calcium oxide, and aluminum oxide.

In another embodiment, the substrate surface is a metal sulfide, a metal selenide, or a metal telluride. Some examples of metal sulfides suitable as substrate surfaces include cadmium sulfide, gallium sulfide, iron sulfide, nickel sulfide, copper sulfide, lead sulfide, and zinc sulfide. Some examples of metal selenides suitable as substrate surfaces include cadmium selenide, gallium selenide, copper selenide, and zinc selenide. Some examples of metal tellurides suitabel as substrate surfaces include cadmium telluride, antimony telluride, arsenic telluride, bismuth telluride, copper telluride, europium telluride, gallium telluride, manganese telluride, lead telluride, and zinc telluride.

In another embodiment, the substrate surface is a metal nitride, metal phosphide, metal arsenide, or metal antimonide. Some examples of metal nitrides suitable as substrate surfaces include gallium nitride, indium nitride, aluminum nitride, and boron nitride. Some examples of metal phosphides suitable as substrate surfaces include gallium phosphide, indium phosphide, and zinc phosphide. Some examples of metal arsenides suitable as substrate surfaces include gallium arsenide, indium arsenide, and zinc arsenide.

In another embodiment, the substrate surface is a metal boride, a metal aluminide, a metal gallide, or a metal indide. Some examples of metal borides suitable as substrate surfaces include vanadium boride, barium boride, calcium boride, chromium boride, cobalt boride, hafnium boride, lanthanum boride, magnesium boride, molybdenum boride, nickel boride, tantalum boride, titanium boride, and zirconium boride.

In another embodiment, the substrate surface is a metal carbide. Some examples of metal carbides suitable as substrate surfaces include tungsten carbide, silicon carbide, molybdenum carbide, titanium carbide, aluminum carbide, vanadium carbide, boron carbide, lithium carbide, barium carbide, calcium carbide, and tantalum carbide.

In another embodiment, the substrate surface is a metal silicide. Some examples of metal silicides suitable as substrate surfaces include vanadium silicide, boron silicide, calcium silicide, chromium silicide, cobalt silicide, copper silicide, lanthanum silicide, magnesium silicide, molybdenum silicide, nickel silicide, niobium silicide, iron silicide, titanium silicide, tungsten silicide, and zirconium silicide.

In another embodiment, the substrate surface is a metal salt. The metal salt is composed of any suitable metal ion in combination with a suitable counteranion. Preferably, the metal salt is composed of one or more alkali or alkaline earth metal ions in combination with one or more counteranions. Some examples of counteranions include halide, sulfate, nitrate, phosphate, carboxylate, borate, carbonate, silicate, selenoate, and arsenate. The metal salt is preferably in the form of a crystalline phase.

In another embodiment, the substrate surface is a superconducting material. For example, the substrate surface can be in the class of copper oxide superconducting materials. Some examples of copper oxide superconducting materials include the yttrium barium copper oxide (Y—Ba—Cu—O) class of superconductors. Another example of a superconducting material is magnesium boride.

In another embodiment, the substrate surface is a conducting polymer. Some examples of conducting polymers include polyaniline, polypyrrole, polythiophene, poly(para-phenylene), poly(p-phenylenevinylene), polyacetylene, and combinations thereof. The examples given above include chemical derivatives thereof and doped derivatives thereof.

The substrate surface can be chemically the same, or different from, the bulk substrate, i.e., the non-surface portion of the substrate. Any of the foregoing materials suitable as substrate surfaces, as described above, are also suitable as the bulk substrate. Accordingly, any combination of bulk substrate and substrate surface from the materials described above is contemplated in the present invention. For example, a substrate surface can be composed of n- or p-doped silicon oxide, while the remainder of the substrate is composed of n- or p-doped silicon. Alternatively, for example, a substrate can be composed of gold while having a conducting polymer coated thereon as the substrate surface. Or, for example, the substrate can be a composite structure or laminate having layers of various metals or other materials therein.

For example, the invention includes a substrate having a non-conductive bulk component coated with a layer which is at least partially electrically conductive. Accordingly, a non-conductive substrate coated with any of the substrate surface materials described above is suitable according to the invention. Some examples of non-conductive substrates include non-conductive ceramics and non-conductive organic molecules, polymers, and plastics.

The surface to be patterned must include oxidizable groups. The groups are capable of being oxidized by the negative voltage applied from the ultrafine tip. Some examples of preferred oxidizable groups include methyl, vinyl, acetylenyl, and mercapto groups. One or more of the same, or any suitable combination of, the foregoing oxidizable groups is also contemplated.

The oxidizable methyl group is made of one primary carbon atom bound to at least one hydrogen atom. Accordingly, any substituted methyl group is contemplated. However, any such substituting group on the methyl group must not prevent oxidation of the methyl group by the tip. Preferably, the oxidizable methyl group is according to the formula —CH₃.

The oxidizable vinyl group is made of two carbon atoms connected by a double bond. The carbon atoms can be substituted or unsubstituted. Some examples of substituted vinyl groups include —CH═CH(CH₃), —CH═C(CH₃)₂, and —C(CH₃)═C(CH₃)₂. Preferably, the oxidizable vinyl group is unsubstituted, and is hence, represented by the formula —CH═CH₂.

The oxidizable acetylenyl group is made of two carbon atoms connected by a triple bond. The carbon atoms can be substituted or unsubstituted. An example of a substituted acetylenyl group is —C≡C(CH₃). Preferably, the oxidizable acetylenyl group is represented by the formula —C—CH.

The oxidizable mercapto group is any group containing one or more sulfur atoms, most notably the thiol group (SH) or its related analogs, e.g., sulfinyl, sulfonyl, and disulfidyl (—S—SH) groups.

By applying a negative voltage to the ultrafine tip, the oxidizable groups, as described above, are converted to an oxidized form. The voltage bias of the tip is preferably transient, i.e., is applied only during the writing process. The writing process is the process wherein oxidizable groups on the substrate surface are simultaneously oxidized by the voltage applied by the tip and reacted with patterning molecules supplied by the tip.

The voltage bias of the ultrafine tip is negative with respect to the substrate surface, and hence, is referred to as a negative voltage bias. A negative voltage bias of the tip with respect to the substrate surface can be equivalently referred to as a positive voltage bias of the substrate surface with respect to the tip.

Preferably, the negative voltage bias of the ultrafine tip is a minimum of approximately five volts. The maximum voltage is dependent on the writing speed, and thus, there is no particular upper limit for the voltage. However, especially as concerns the limitations of scanning probe machines currently available, the voltage is preferably within the range of approximately 5 to 15 volts.

Preferably, the oxidized form of the methyl, vinyl, and acetylenyl oxidizable groups includes a carboxylic acid group (COOH). The oxidized form of the methyl, vinyl, and acetylenyl oxidizable groups can also include a certain proportion of groups that have not been completely oxidized to carboxylic acid groups. For example, a certain proportion of the oxidized groups can be aldehyde groups ((C═O)H). The aldehyde group is capable of reacting with numerous species that can be present in the patterning molecules, including phenolic and amino groups. The oxidized form of the mercapto group is preferably a sulfonic acid group (SO₃H).

For any of the oxidizable groups, the resulting oxidized form is capable of either catalyzing a hydrolysis reaction of, or reacting with, the patterning molecules on the ultrafine tip. For example, carboxylic acid groups are capable of catalyzing hydrolysis reactions of metal alkoxides and metal amides. Carboxylic acid groups are also capable of reacting with, for example: an amine, to produce a carboxylate-ammonium salt complex, or an amide bond under appropriate conditions; an alcohol, to produce, under appropriate conditions, a carboxylate ester; or an epoxide, to produce an alcohol-ester.

The carboxylic acid groups in the oxidized form are also capable of reacting with patterning molecules having one or more quaternary ammonium groups by forming a carboxylate-quaternary ammonium ionic complex with such patterning molecules. Some examples of suitable quaternary ammonium groups in such patterning molecules include ammonium, methylammonium, dimethylammonium, trimethylammonium, tetramethylammonium, tetraethylammonium, tetrapropylammonium, tetrabutylammonium, tetraphenylammonium, phenyltrimethylammonium, hexyltrimethylammonium, heptyltrimethylammonium, octyltrimethylammonium, nonyltrimethylammonium, decyltrimethylammonium, dodecyltrimethylammonium, hexadecyltrimethylammonium, octadecyltrimethylammonium, eicosyltrimethylammonium, docosyltrimethylammonium, and triacontyltrimethylammonium.

In addition, the carboxylic acid groups can simultaneously catalyze hydrolysis reactions of, and crosslink with, appropriate patterning molecules. For example, the carboxylic acid groups can hydrolyze siloxane patterning molecules to form a crosslinked secondary layer of siloxane molecules while also forming carboxy-silyl ester linkages to the crosslinked siloxane molecules.

The sulfonic acid group in the oxidized form of a mercapto group functions similarly to the carboxylic acid groups described above. For example, the sulfonic acid group is capable of catalyzing hydrolysis reactions of, for example, metal alkoxides and metal amides. The sulfonic acid group is also capable of reacting with, for example: an amine, to produce a sulfonate-ammonium salt complex, or a sulfonamide bond under appropriate conditions; an alcohol, to produce, under appropriate conditions, a sulfonate ester; a quaternary ammonium salt, to produce a sulfonate-quaternary ammonium ionic complex.

In one embodiment, the substrate surface contains, by its own chemical construction, any of the oxidizable groups described above. Such a substrate surface can also optionally be at least partially covered by substrate surface molecules having any such oxidizable groups.

In another embodiment, the substrate surface does not, by its own chemical construction, contain such oxidizable groups. In such a case, the substrate surface is at least partially covered with substrate surface molecules, of which at least a portion contain the oxidizable groups described above.

The oxidizable groups on the substrate or in the substrate surface molecules need to be accessible to the ultrafine tip. Preferably, to be accessible, the oxidizable groups are at least close to terminal locations of the substrate surface molecules. A terminal location is a location on the substrate or substrate surface molecule which is farthest from the substrate surface.

For example, an oxidizable group is preferably within no more than three, four, or perhaps five atomic bonds from a terminal position. More preferably, the oxidizable groups are in terminal locations of the substrate surface molecules.

The substrate surface molecules are not particularly limited, other than that at least a portion of the substrate surface molecules must have oxidizable groups. In addition, the substrate surface molecules preferably engage in a positive interaction with the substrate surface in order to properly adhere to the substrate surface during the patterning process. For example, the substrate surface molecules can be covalently or non-covalently bonded to the substrate surface. Covalent bonding of the substrate surface molecules can result from, for example, the reaction of nucleophilic molecules with a substrate surface having leaving groups, such as halogen atoms or tosylate groups. Non-covalent bonding includes van der Waals attraction, ionic bonding, hydrogen bonding, metal-ligand or coordination bonding, dative bonding, and the like.

The substrate surface molecules are also preferably capable of forming positive intermolecular interactions, including intermolecular bonds, with each other. The intermolecular interactions can be covalent or non-covalent in nature, such as by van der Waals interactions, ionic bonding, hydrogen bonding, metal ligand or coordination bonding, and so on.

For example, hydrocarbon substrate surface molecules, such as eicosane, 21-docosene, and 9,10-dimethylphenanthrene, interact through weak van der Waals forces. Fluorocarbon-containing molecules interact through more polarized van der Waals forces. Intermolecular ionic bonding occurs between substrate surface molecules which can form salt complexes with each other, such as by interaction of quaternary ammonium groups with carboxylate or sulfonate groups. Hydrogen bonding intermolecular interactions occurs between substrate surface molecules that have hydrogen-accepting and hydrogen-donating groups. For example, hydrogen bonding interactions typically occur between substrate surface molecules when one portion of them has amino-containing or purinyl groups and the other portion has, for example, pyrimidino groups.

Substrate surface molecules having one or more groups which are reactive with metal atoms can form metal ligand intermolecular bonds between such substrate surface molecules. For example, substrate surface molecules bearing amino groups can be reacted with transition metals to form N-M-N intermolecular linkages, wherein M represents the transition metal.

Alternatively, for example, a reactive metal complex can be reacted with ordinarily unreactive components of substrate surface molecules to form metal ligand intermolecular bonds between such substrate surface molecules. For example, substrate surface molecules bearing alkenyl or alkynyl groups may be reacted with osmium derivatives, such as OsO₄, to form carbon-osmium-carbon intermolecular linkages.

Still further, substrate surface molecules containing ring-strained or unsaturated components can be induced to undergo ring-forming or other crosslinking reactions by exposure to a high energy source, such as ultraviolet light.

In a preferred embodiment, substrate surface molecules are capable of forming both a positive interaction with the substrate surface and positive intermolecular interactions (or bonds). Preferably, by the combination of these interactions, the substrate surface molecules form a cohesive layer that resists dissolution during the patterning process. More preferably, the substrate surface molecules form an ordered molecular monolayer on the substrate surface. Even more preferably, the ordered molecular monolayer is capable of self-assembling, i.e., of producing a self-assembled monolayer (SAM) on the substrate surface.

In one embodiment, the substrate surface molecules are hydrocarbon molecules. The size of the hydrocarbon molecules is not particularly limited. For example, the hydrocarbon molecules can be polymeric in nature and have weights typical of polymers, e.g., molecular weights in the tens of thousands. Alternatively, the hydrocarbon molecules can be large molecules having up to 500 carbon atoms; or smaller molecules having up to approximately 100 carbon atoms; or even smaller molecules having approximately 1 to 50 carbon atoms.

The hydrocarbon molecules can be saturated or unsaturated, straight-chained or branched, cyclic, polycyclic, fused ring, or acyclic in nature.

In one embodiment, the hydrocarbon molecules are completely acyclic in nature. The acyclic hydrocarbon molecules can be saturated and straight-chained, i.e., straight-chained alkanes. Some examples of straight-chained alkanes include methane, ethane, propane, n-butane, pentane, hexane, octane, nonane, decane, dodecane, hexadecane, eicosane, docosane, hexacosane, triacontane, tetracontane, pentacontane, and the like.

The acyclic hydrocarbon molecules can also be saturated and branched, i.e., branched alkanes. Some examples of branched alkanes include iso-butane, t-butane, di-(t-butyl)methane, 3-ethyl-2,3-dimethylhexane, and 4-(1,1-dimethylethyl)heptane.

The acyclic hydrocarbon molecules can alternatively be unsaturated. Unsaturated hydrocarbon molecules include, for example, alkenes, alkynes, and combinations thereof, i.e., enynes.

The unsaturated acyclic hydrocarbon molecules can be straight-chained. Some examples of straight-chained alkenes include ethene, allene, 1-butene, 2-butene, 1-hexene, 1,3-hexadiene, 1,3,5-hexatriene, octene, decene, hexadecene, and eicosene. Some examples of straight-chained alkynes include acetylene, 1-butyne, 1-hexyne, 1-octyne, and 2,5-hexadiyne. Some examples of straight-chained enynes include hex-1-en-3-yne and hexa-1,5-dien-3-yne.

The unsaturated acyclic hydrocarbon molecules can alternatively be branched. Some examples of branched alkenes include 2-methylene-3-butene, 2,3-dimethylbut-2-ene, and 2,3-dimethyl-icos-1-ene. Some examples of branched alkynes include 2,5-dimethyl-hex-3-yne and 2,3-dimethyl-icos-1-yne.

In another embodiment, the acyclic hydrocarbon molecules described above include one or more cyclic hydrocarbon moieties to make cyclic hydrocarbon molecules. The cyclic hydrocarbon molecules are substituted with one or more oxidizable groups as described above.

The cyclic hydrocarbon moiety can be, for example, a four, five, six, seven, or eight member ring. The ring can be saturated or unsaturated. An unsaturated ring contains at least one double bond. For example, a five member ring can have one or two double bonds, and a seven member ring can have one to three double bonds.

In one embodiment, the ring is a carbocyclic ring. The carbocyclic ring can be saturated. Some examples of suitable saturated carbocyclic rings include cyclobutane, cyclopentane, cyclohexane, cycloheptane, and cyclooctane rings.

Alternatively, the carbocyclic ring can be unsaturated. The unsaturated carbocyclic rings can be either aromatic, i.e., “aryl” or “arenyl,” or non-aromatic.

Examples of unsaturated carbocyclic rings include cyclopentene, cyclohexene, cycloheptene, cyclopentadiene, 1,3-cyclohexadiene, 1,4-cyclohexadiene, 1,3-cycloheptadiene, cycloheptatriene, cyclooctadiene, and phenyl rings.

Any of the carbocyclic rings described above can also be polycyclic. Some examples of polycyclic carbocyclic ring systems include bicyclo[2.2.2]octane and bicyclo[3.3.3]undecane.

Any of the carbocyclic rings described above can also be fused to one or more, typically one or two, other carbocyclic rings to make a carbocyclic fused ring system. Some examples of completely saturated carbocyclic fused ring systems include decahydronaphthalene, tetradecahydroanthracene, tetradecahydrophenanthrene and hexadecahydropyrene fused rings. Some examples of unsaturated carbocyclic fused ring systems which are non-aromatic include bicyclo[4.3.0]non-3-ene, bicyclo[4.4.0]dec-8-ene, and bicyclo[4.4.0]dec-7,9-diene fused rings. Some examples of aromatic carbocyclic fused ring systems include naphthalene, phenanthrene, anthracene, triphenylene, azulene, chrysene, pyrene, and biphenylene fused rings.

Any of the acyclic, cyclic, polycyclic, or fused hydrocarbon molecules described above optionally have one or more carbon atoms substituted by one or more heteroatom linkers or heteroatom groups. Alternatively, or in addition, any of the hydrocarbon molecules can have one or more hydrogen atoms substituted by one or more heteroatom groups. When the hydrocarbon molecule is substituted by more than one heteroatom linker or group, the heteroatom linkers and/or groups can be the same or different.

Some examples of heteroatom linkers include —O—, —O—O—, —S—, —S—S—, —S(O)—, —S(O)₂—, —Se—, —N═N—, —C(O)—, —C(O)NH—, —C(O)O—, —C(S)O—, —NR⁷—, —NR⁷C(O)O—, —NR⁷—NR⁷—, —NR⁷C(O)NR⁷—, ═N—NR⁷—, —P(R⁷)—, —C(O)—O—C(O)—, and silano groups.

Some examples of heteroatom groups include halo, silano, —OR⁷, —SR⁷, —SeR⁷, —TeR⁷, —S—SR⁷, —N(R⁷)₂, —N(R⁷)₃⁺, —N₃, —NO₂, —C(O)N(R⁷)₂, —C(O)R⁷, —C(O)O⁻, —C(O)OR⁷, —C(S)OR⁷, —NR⁷C(O)OR⁷, —NR⁷C(O)NR⁷, —NR⁷—N(R⁷)₂, —N═N(R⁷), ═N—N(R⁷)₂, —OCN, —NCO, —SCN, —NCS, —P(R⁷)₂, —P(OR⁷)₂, —As(R⁷)₂, —CN, —NC, —S(O)₂OH, —S(O)₂O⁻, —P(O)(OH)₂, —PO₃²⁻, and —C(O)—O—C(O)R⁷. The term “halo” includes, for example, F, Cl, and Br.

A silano group is any group which includes one or more silicon atoms. Some examples of silano groups include the following: —Si(R⁷)₃, —Si(R⁷)₂—, —Si(R⁷)═, —Si≡, —SiCl₃, —SiCl₂—, —SiCl═, —Si(O—)₃, —Si(O—)₂—, —Si(O—)═, —Si(OR⁷)₃, —SiR⁷(OR⁷)₂, —Si(R⁷)₂(OR⁷), —SiCl(OR⁷)₂, and —Si(Cl)₂(OR⁷).

The symbol ═ represents two separate single bonds wherein each single bond is between a silicon atom and a carbon atom or between a silicon atom and a suitable heteroatom. Similarly, the symbol ≡ represents three separate single bonds wherein each single bond is between a silicon atom and a carbon atom or between a silicon atom and a suitable heteroatom.

In the heteroatom groups above, R⁷ independently represents H, or any of the hydrocarbon groups described above. Preferably, R⁷ represents a saturated or unsaturated, straight-chained or branched, cyclic or acyclic hydrocarbon group having 1 to 6 carbon atoms.

Some examples of saturated acyclic groups for R⁷ include methyl, ethyl, n-propyl, isopropyl, n-butyl, sec-butyl, i-butyl, t-butyl, n-pentyl, n-hexyl, 4-methyl-2-pentyl, and so on. Some examples of unsaturated acyclic groups for R⁷ include vinyl, propenyl, isopropenyl, butenyl, propargyl, and so on.

Some examples of saturated cyclic groups for R⁷ include cyclopropyl, cyclobutyl, cyclopentyl, and cyclohexyl. Some examples of unsaturated cyclic groups for R⁷ include cyclobutene, cyclopentene, cyclohexene, and phenyl.

Accordingly, in one embodiment, the acyclic hydrocarbon molecule is heteroatom-substituted with one or more —O— groups to form an alkyleneoxide or polyalkyleneoxide. Some examples of polyalkyleneoxides include polymethyleneoxide, polyethyleneoxide, polypropylenenoxide, and combinations thereof.

When one or more carbon atoms of the carbocyclic rings described above are substituted by one or more heteroatoms described above, a heterocyclic ring is formed.

The heterocyclic ring can be saturated. Examples of saturated heterocyclic rings containing one or more nitrogen heteroatoms include pyrrolidine, piperidine, imidazolidine, N,N′-dimethylimidazolidine, pyrazolidine, piperazine, homopiperazine, and hexahydro-1,3,5-triazine rings. Examples of saturated heterocyclic rings containing one or more oxygen heteroatoms include tetrahydrofuran, tetrahydropyran, and 1,4-dioxane rings. Examples of saturated heterocyclic rings containing one or more sulfur heteroatoms include tetrahydrothiophene and 1,4-dithiane rings. Examples of saturated heterocyclic rings containing a combination of heteroatoms include 1,3-oxazolidine, 1,3-thiazolidine, 1,3-oxathiolane, and morpholine rings.

Alternatively, the heterocyclic ring can be unsaturated. The unsaturated heterocyclic rings can be either aromatic, i.e., “heteroaryl” or “heteroarenyl,” or non-aromatic.

Examples of unsaturated heterocyclic rings containing one or more nitrogen heteroatoms include pyrrole, pyridine, pyrazole, pyrazine, pyrimidine, imidazole, and triazine rings. Examples of unsaturated heterocyclic rings containing one or more oxygen heteroatoms include furan, pyran, and 1,3-dioxole rings. Examples of unsaturated heterocyclic rings containing one or more sulfur heteroatoms include thiophene, thiopyran, 1,3-dithiole, and 1,3-dithiine rings. Examples of unsaturated heterocyclic rings containing a combination of heteroatoms include oxazole, thiazole, and oxathiole rings.

Any of the polycyclic carbocyclic rings described above can also be substituted to form polycyclic heterocyclic rings. Some examples of polycyclic heterocyclic rings include 1,4-diazabicyclo[2.2.2]octane and 1,5-diaza-bicyclo[3.3.3]undecane.

In addition, any of the heterocyclic rings or polycyclic heterocyclic rings described above can be fused to one or more, typically one or two, other rings to make a heterocyclic fused ring system.

In one embodiment, the heterocyclic fused ring system is composed of a mixture of carbocyclic and heterocyclic rings. Some examples of such fused ring systems include indoline, quinoline, isoquinoline, phthalazine, benzimidazole, benzothiazole, benzisoxazole, benzodioxole, quinoxaline, quinazoline, benzoxazine, cinnoline, acridine, and phenazine fused rings.

In another embodiment, the heterocyclic fused ring system is composed of only heterocyclic rings. Examples of such fused ring systems include pteridine, purine, 1,8 naphthyridine, 1,8,9-triazaanthracene, 1,5-diazabicyclo[4.3.0]non-5-ene and thieno[3,2-b]furan fused rings.

In a preferred embodiment, one or more carbon atoms and/or one or more hydrogen atoms of at least a portion of any of the hydrocarbon molecules described above, on the substrate surface, are substituted by one or more heteroatom groups. More preferably, the heteroatom groups are groups which allow for stronger positive interaction with the substrate surface, and/or stronger intermolecular cohesion.

In a further preferred embodiment, at least a portion of the substrate surface molecules are substituted by one or more silano groups, as described above. For example, the surface substrate molecules can be any of the hydrocarbon groups described above substituted by one or more silano groups described above.

More preferably, at least a portion of the substrate surface molecules are siloxane molecules. The class of siloxane molecules includes the class of alkoxysilanes, which further includes the classes of monoalkoxysilanes, dialkoxysilanes, trialkoxysilanes, and tetraalkoxysilanes, i.e., tetraalkylorthosilicates.

The term “alkoxy” or “alkoxide” as used herein, refers to any of the substituted or unsubstituted hydrocarbon groups described above, including a silano group as described above, bound to an oxygen atom. Preferably, the hydrocarbon component of the alkoxy group is a saturated or unsaturated, straight-chained or branched, cyclic or acyclic hydrocarbon group having 1 to 6 carbon atoms.

Some examples of alkoxy or alkoxide groups include methoxide, trifluoromethoxide, ethoxide, pentafluoroethoxide, propoxide, isoproxide, butoxide, t-butoxide, vinyloxide, allyloxide, phenoxide, trimethylsilyloxide, triethylsilyloxide triisopropylsilyloxide, and the like.

Siloxane molecules are particularly suitable for coating metal oxide surfaces. As known in the art, alkoxysilanes in the presence of water hydrolyze to form the corresponding hydroxysilanes. The alkoxysilanes can react with water found in, for example, an aqueous solution containing the alkoxysilanes. Alternatively, for example, alkoxysilanes react with water molecules adsorbed onto a substrate surface, and thus, crosslink via surface-mediated hydrolysis.

The hydroxyl groups of hydroxysilanes are known to react with various surfaces. For example, hydroxysilanes are known to condense with the hydroxyl groups of metal oxide surfaces to form silicon-oxide-metal (Si—O-M) bonds. In the following formula, a monohydroxysilane is shown crosslinking with a metal oxide surface:

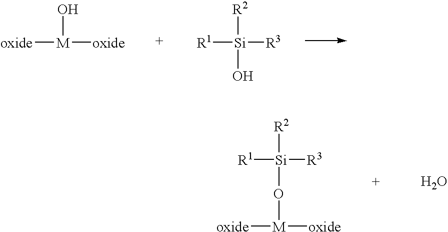

The metal in the silicon-oxide-metal bond is a metal found in the metal oxide surface. Metal oxide surfaces, and examples thereof, were described above. In a preferred embodiment, the metal oxide surface is a silicon oxide surface. Accordingly, the silicon-oxide-metal bond shown above is a silicon-oxide-silicon (Si—O—Si) bond.

Hydrolyzed trialkoxysilanes and tetraalkoxysilanes have additional hydroxyl groups remaining after linking with the surface. The remaining hydroxyl groups of these molecules may further condense, partially or completely, to form silicon-oxide-silicon bonds, as shown in the following formula:

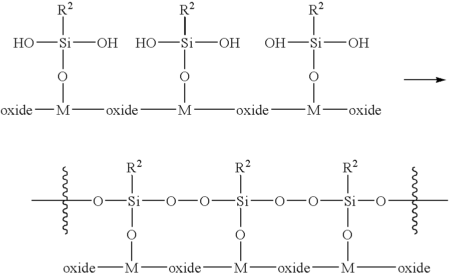

In a preferred embodiment, the siloxane molecules are represented by the formula:
R¹ₙR²ₘR³ₚSi(OR⁴)₄₋ₘ₋ₙ₋ₚ (1)

In formula (1), R¹, R², and R³ independently represent H or any of the hydrocarbon groups described above for the substrate surface molecules. For example, in a preferred embodiment, R¹, R², and R³ independently represent saturated or unsaturated; straight-chained or branched; cyclic, polycyclic, fused ring, or acyclic hydrocarbon groups having 1 to 50 carbon atoms. Optionally, one or more carbon atoms of the hydrocarbon groups are substituted by one or more heteroatom linkers or heteroatom groups. Alternatively, or in addition, one or more hydrogen atoms of the hydrocarbon groups are substituted by one or more heteroatom groups.

R⁴ independently represents H, a silano group as described above, or any of the hydrocarbon groups described above. Preferably, R⁴ represents a saturated or unsaturated; straight-chained or branched; cyclic or acyclic hydrocarbon group having 1 to 6 carbon atoms.

The subscripts m, n, and p in formula (1) independently represent 0 or 1. Accordingly, formula (1) represents a monoalkoxysilane when m, n, and p are each 1; a dialkoxysilane when the sum of m, n, and p is 2; a trialkoxysilane when the sum of m, n, and p is 1, and a tetraalkoxysilane when m, n, and p are each 0.

In formula (1), at least one of m, n, and p is 1 and at least one of R¹, R², and R³ groups represents the hydrocarbon groups of R¹, R², and R³. Alternatively, when m, n, and p are all 0, then R⁴ represents the hydrocarbon groups of R⁴, wherein at least a portion of the hydrocarbon groups of R⁴ are terminated with an oxidizable group, such as methyl, vinyl, acetylenyl, or mercapto groups, or a combination thereof.

In a preferred embodiment, at least a portion of the surface siloxane molecules according to formula (1) are trialkoxysilanes. Preferably, the trialkoxysilanes are represented by the formula:
R¹Si(OR⁴)₃ (3)

In formula (3), R¹ represents any of the hydrocarbon groups described above. R⁴ is as defined above in formula (1).

In a further embodiment of formula (3), R¹ is represented by the formula CH₃(CH₂)ₙ—. In the foregoing formula, s represents 0, or an integer from 1 to 30. Preferably, s represents an integer from 10 to 20. Even more preferably, s is approximately 17. When s is 17, formula (3) represents the class of substituted and unsubstituted octadecyltrialkoxysilanes.

Some examples of monoalkoxysilanes suitable as substrate surface molecules include trimethylmethoxysilane, triethylmethoxysilane, tripropylmethoxysilane, tributylmethoxysilane, dibutylmethylmethoxysilane, decyldinethylmethoxysilane, dodecyldimethylmethoxysilane, hexadecyldimethylmethoxysilane, octadecyldimethylmethoxysilane, eicosyldimethylmethoxysilane, docosyldimethylmethoxysilane, triacontyldimethylmethoxysilane, vinyldimethylmethoxysilane, 7-octenyldiethyl-methoxysilane, 10-undecenyldimethylmethoxysilane, methacryloxymethyldimethyl methoxysilane, methacryloxypropyldimethylmethoxysilane, allylmethoxysilane, 15-hexadecenyldipropylmethoxysilane, 17-octadecenyldimethylmethoxysilane, 19-eicosenyldimethylmethoxysilane, 21-docosenyldimethylmethoxysilane, (mercaptomethyl)dimethylmethoxysilane, (3-mercaptopropyl)dimethylmethoxysilane, (8-mercaptooctyl)dimethylmethoxysilane, (11-mercaptoundecyl)dimethylmethoxy-silane, (16-mercaptohexadecyl)dimethylmethoxysilane, (18-mercaptooctadecyl)-dimethylmethoxysilane, (20-mercaptoeicosyl)dipropylmethoxysilane, and the like.

Some examples of dialkoxysilanes suitable as substrate surface molecules include dimethyldimethoxysilane, diethyldimethoxysilane, dipropyldimethoxysilane, dibutyldimethoxysilane, butylmethyldimethoxysilane, decylmethyldimethoxysilane, dodecylmethyldimethoxysilane, hexadecylmethyldimethoxysilane, octadecylmethyldimethoxysilane, eicosylmethyldimethoxysilane, docosylmethyldimethoxysilane, triacontylmethyldimethoxysilane, vinylmethyldimethoxysilane, 7-octenylethyldimethoxysilane, 10-undecenylmethyldimethoxysilane, methacryloxymethylmethyldimethoxysilane, methacryloxypropylmethyldimethoxysilane, allyldimethoxysilane, 15-hexadecenylpropyldimethoxysilane, 17-octadecenylmethyldimethoxysilane, 19-eicosenylmethyldimethoxysilane, 21-docosenylmethyldimethoxysilane, (mercaptomethyl)methyldimethoxysilane, (3-mercaptopropyl)methyldimethoxysilane, (8-mercaptooctyl)methyldimethoxysilane, (11-mercaptoundecyl)methyldimethoxy-silane, (16-mercaptohexadecyl)methyldimethoxysilane, (18-mercaptooctadecyl)-methyldimethoxysilane, (20-mercaptoeicosyl)propyldimethoxy silane, and the like.

Some examples of trialkoxysilanes suitable as substrate surface molecules, as described by formula (3), include methyltrimethoxysilane, ethyltrimethoxysilane, n-propyltrimethoxysilane, iso-propyltrimethoxysilane, n-butyltrimethoxysilane, iso-butyltrimethoxysilane, t-butyltrimethoxysilane, n-pentyltrimethoxysilane, n-hexyltrimethoxysilane, n-heptyltrimethoxysilane, n-octyltrimethoxysilane, n-nonyltrimethoxysilane, n-decyltrimethoxysilane, n-undecyltrimethoxysilane, n-hexadecyltrimethoxysilane, n-octadecyltrimethoxysilane, n-eicosyltrimethoxysilane, n-docosyltrimethoxysilane, n-triacontyltrimethoxysilane, n-tetracontyltrimethoxysilane, n-pentacontyltrimethoxysilane, vinyltrimethoxysilane, 7-octenyltrimethoxysilane, 10-undecenyltrimethoxysilane, methacryloxymethyltrimethoxysilane, methacryloxypropyltrimethoxysilane, allyltrimethoxysilane, 15-hexadecenyltrimethoxysilane, 17-octadecenyltrimethoxysilane, 19-eicosenyltrimethoxysilane, 21-docosenyltrimethoxysilane, mercaptomethyltrimethoxysilane, 3-mercaptopropyltrimethoxysilane, 8-mercaptooctyltrimethoxysilane, 11-mercaptoundecyltrimethoxysilane, 16-mercaptohexadecyltrimethoxysilane, 18-mercaptooctadecyltrimethoxysilane, 20-mercaptoeicosyltrimethoxy silane, and the like.

In all of the foregoing examples of monoalkoxysilanes, dialkoxysilanes, and trialkoxysilanes, one or more alkoxy groups can be substituted by one or more hydroxy groups. Complete substitution by hydroxy groups would make the corresponding monohydroxysilanes, dihydroxysilanes, and trihydroxysilanes, all of which are within the scope of the present invention.

In addition, in all of the foregoing examples of methoxysilanes, the methoxy group can be substituted by, for example, ethoxy, propoxy, isopropoxy, butoxy, phenoxy, siloxy, or a combination thereof, to make the corresponding mono-, di-, and tri-alkoxy and siloxy silanes.

Some examples of suitable tetraalkoxysilanes include tetramethoxysilane, tetraethoxysilane, tetrapropoxysilane, tetraisopropoxysilane, tetrakis(butoxyethoxyethoxy)silane, tetrakis(dimethylsiloxy)silane, tetrakis(ethoxyethoxy)silane, tetrakis(2-ethylhexoxy)silane, tetrakis(2-hydroxyethoxy)silane, tetrakis(methoxyethoxyethoxy)silane, tetrakis(methoxyethoxy)silane, tetrakis(methoxypropoxy)silane, tetrakis(trimethylsiloxy)silane, and tetrakis(vinyldimethylsiloxy)silane.

In a preferred embodiment, the crosslinked surface siloxane molecules described above are formed on the substrate surface by surface-mediated hydrolysis of the corresponding chlorosilane precursors. Chlorosilane precursors include monochlorosilanes, dichlorosilanes, and trichlorosilanes.

An advantage of the chlorosilane precursors is that they are much more reactive than the corresponding siloxanes with regard to crosslinking to metal oxide surfaces. Accordingly, chlorosilane precursors form a layer of crosslinked surface siloxanes much faster than the corresponding siloxanes.

For example, a trichlorosilane molecule can react with a metal oxide surface to form a Si—O-M bond as follows:

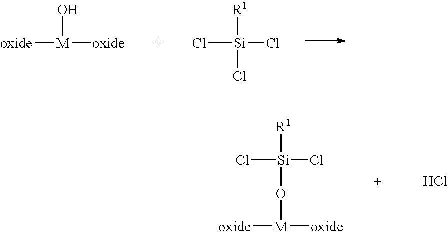

The remaining chloro groups in the formula above can be hydrolyzed by surface-adsorbed water, if present, to form hydroxysilanes. The hydroxysilanes can crosslink to form intermolecular Si—O—Si bonds, as described earlier.

In a preferred embodiment, suitable chlorosilane precursors to formula (1) above are represented by the following formula:
R¹ₙR²ₘR³ₚSiCl₄₋ₘ₋ₙ₋ₚ (2)

In formula (2), R¹, R², and R³ independently represent H, or any of the hydrocarbon groups described above for the substrate surface molecules, and as described for R¹, R², and R³ in formula (1). The subscripts m, n, and p independently represent 0 or 1 provided that at least one of n, m, and p is not 0, and at least one of R¹, R², and R³ is not H.

Accordingly, formula (2) represents a monochlorosilane when the sum of m, n, and p is 3, i.e., when m, n, and p are each 1; a dichlorosilane when the sum of m, n, and p is 2; and a trichlorosilane when the sum of m, n, and p is 1.

Preferably, suitable trichlorosilane precursors are used to generate crosslinked versions of the trialkoxysilanes of formula (3). The trichlorosilane precursors can be represented by the formula:
R¹SiCl₃ (4)

In formula (4), R¹ represents any of the hydrocarbon groups described above. In a further embodiment of formula (4), R¹ is represented by the formula CH₃(CH₂)ₛ—. In the foregoing formula, s represents 0, or an integer from 1 to 30. Preferably, s represents an integer from 10 to 20. Even more preferably, s is approximately 17. When s is 17, formula (4) represents the class of substituted and unsubstituted octadecyltrichlorosilanes.

Some examples of suitable monochlorosilane precursors include trimethylchlorosilane, triethylchlorosilane, tripropylchlorosilane, tributylchlorosilane, dibutylmethylchlorosilane, decyldimethylchlorosilane, dodecyldimethylchlorosilane, hexadecyldimethylchlorosilane, octadecyldimethylchlorosilane, eicosyldimethylchlorosilane, docosyldimethylchlorosilane, triacontyldimethylchlorosilane, vinyldimethylchlorosilane, 7-octenyldiethyl-chlorosilane, 10-undecenyldimethylchlorosilane, methacryloxymethyldimethyl-chlorosilane, methacryloxypropyldimethylchlorosilane, allylchlorosilane, 15-hexadecenyldipropylchlorosilane, 17-octadecenyldimethylchlorosilane, 19-eicosenyldimethylchlorosilane, 21-docosenyldimethylchlorosilane, (mercaptomethyl)dimethylchlorosilane, (3-mercaptopropyl)dimethylchlorosilane, (8-mercaptooctyl)dimethylchlorosilane, (11-mercaptoundecyl)dimethylchloro-silane, (16-mercaptohexadecyl)dimethylchlorosilane, (18-mercaptooctadecyl)-dimethylchlorosilane, (20-mercaptoeicosyl)dipropylchlorosilane, and the like.

Some examples of suitable dichlorosilane precursors include dimethyldichlorosilane, diethyldichlorosilane, dipropyldichlorosilane, dibutyldichlorosilane, butylmethyldichlorosilane, decylmethyldichlorosilane, dodecylmethyldichlorosilane, hexadecylmethyldichlorosilane, octadecylmethyldichlorosilane, eicosylmethyldichlorosilane, docosylmethyldichlorosilane, triacontylmethyldichlorosilane, vinylmethyldichlorosilane, 7-octenylethyldichlorosilane, 10-undecenylmethyldichlorosilane, methacryloxymethylmethyldichlorosilane, methacryloxypropylmethyldichlorosilane, allyldichlorosilane, 15-hexadecenylpropyldichlorosilane, 17-octadecenylmethyldichlorosilane, 19-eicosenylmethyldichlorosilane, 21-docosenylmethyldichlorosilane, (mercaptomethyl)methyldichlorosilane, (3-mercaptopropyl)methyldichlorosilane, (8-mercaptooctyl)methyldichlorosilane, (11-mercaptoundecyl)methyldichloro-silane, (16-mercaptohexadecyl)methyldichlorosilane, (18-mercaptooctadecyl)-methyldichlorosilane, (20-mercaptoeicosyl)propyldichloro silane, and the like.

Some examples of suitable trichlorosilane precursors according to formula (4) include methyltrichlorosilane, ethyltrichlorosilane, n-propyltrichlorosilane, iso-propyltrichlorosilane, n-butyltrichlorosilane, iso-butyltrichlorosilane, t-butyltrichlorosilane, n-pentyltrichlorosilane, n-hexyltrichlorosilane, n-heptyltrichlorosilane, n-octyltrichlorosilane, n-nonyltrichlorosilane, n-decyltrichlorosilane, n-undecyltrichlorosilane, n-hexadecyltrichlorosilane, n-octadecyltrichlorosilane, n-eicosyltrichlorosilane, n-docosyltrichlorosilane, n-triacontyltrichlorosilane, n-tetracontyltrichlorosilane, n-pentacontyltrichlorosilane, vinyltrichlorosilane, 7-octenyltrichlorosilane, 10-undecenyltrichlorosilane, methacryloxymethyltrichlorosilane, methacryloxypropyltrichlorosilane, allyltrichlorosilane, 15-hexadecenyltrichlorosilane, 17-octadecenyltrichlorosilane, 19-eicosenyltrichlorosilane, 21-docosenyltrichlorosilane, mercaptomethyltrichlorosilane, 3-mercaptopropyltrichlorosilane, 8-mercaptooctyltrichlorosilane, 11 -mercaptoundecyltrichlorosilane, 16-mercaptohexadecyltrichlorosilane, 18-mercaptooctadecyltrichlorosilane, 20-mercaptoeicosyltrichlorosilane, and the like.

The ultrafine tip has, at least initially, a first group of patterning molecules on its surface during the writing process. The first group of patterning molecules are molecules which can be hydrolyzed by, and/or react with, the oxidized form of the substrate surface molecules. Accordingly, the first group of patterning molecules have chemical groups capable of being hydrolyzed by, and/or reacting with, the oxidized form of the substrate surface molecules.

Some suitable first group of patterning molecules include, for example, metal alkoxides and metal amides. The metal alkoxides and metal amides are catalyzed to hydrolyze and crosslink by the carboxylic acid and sulfonic acid groups, particularly in the presence of water, to the corresponding metal oxide polymers containing metal-O-metal bonds.

Metal alkoxides suitable as a first group of patterning molecules include any suitable metal ion in combination with a suitable alkoxide. The metal alkoxide used can be one or a suitable combination of metal alkoxides.

The metal ion in the metal alkoxide is not particularly limited. For example, the metal ion can be selected from the alkali, alkaline earth, main group, transition, lanthanide, and actinide classes of metals.

Some examples of suitable alkali metals in metal alkoxide patterning molecules include lithium (Li), sodium (Na), potassium (K), and rubidium (Rb). Some examples of suitable alkaline earth metals include berrylium (Be), magnesium (Mg), calcium (Ca), strontium (Sr), and barium (Ba). Some examples of suitable main group metals include boron (B), aluminum (Al), gallium (Ga), indium (In), carbon (C), silicon (Si), germanium (Ge), phosphorus (P), arsenic (As), antimony (Sb), sulfur (S), selenium (Se), and tellurium (Te).

Some examples of suitable transition metals in metal alkoxide patterning molecules include the 3d transition metals (the row of transition metals starting with scandium (Sc)); the 4d transition metals (the row of transition metals starting with Yittrium (Y)); and the 5d transition metals (the row of transition metals starting with hafnium (Hf)). Some examples of suitable 3d transition metals include titanium (Ti), vanadium (V), chromium (Cr), manganese (Mn), iron (Fe), nickel (Ni), copper (Cu), and zinc (Zn). Some examples of suitable 4d transition metals include molybdenum (Mo), technetium (Tc), ruthenium (Ru), rhodium (Rh), silver (Ag), and cadmium (Cd). Some examples of suitable 5d transition metals include tantalum (Ta), tungsten (W), rhenium (Re), osmium (Os), iridium (Ir), platinum (Pt), and gold (Au).

Some examples of suitable lanthanide metals in metal alkoxide patterning molecules include lanthanum (La), cerium (Ce), neodymium (Nd), samarium (Sm), europium (Eu), gadolinium (Gd), and terbium (Tb). Some examples of suitable actinide metals include thorium (Th), proctactinium (Pa), uranium (U), and americium (Am).

Particularly preferred metal alkoxides for the first group of patterning molecules are the alkoxysilane class of molecules, i.e., wherein the metal in a metal alkoxide patterning molecule is silicon. Any of the alkoxysilane molecules described above for the substrate surface molecules, including those according to formulas (1) and (3), are suitable as patterning molecules.

For example, the first group of patterning molecules can be any of the monoalkoxy-, dialkoxy-, trialkoxy-, and tetraalkoxy-silanes, and their hydroxy analogs, described above for the surface substrate molecules. More preferably, the siloxane patterning molecules contain at least two alkoxy units. For example, in a preferred embodiment, the first group of siloxane patterning molecules are represented by the formula:
R⁵_{q}R⁶ᵣSi(OR⁴)_{4-q-r} (5)

In formula (5), R⁵ and R⁶ independently represent H; halo; or any of the substituted or unsubstituted hydrocarbon groups previously described above. For example, preferably, R⁵ and R⁶ independently represent H; halo; or saturated or unsaturated; straight-chained or branched; cyclic, polycyclic, fused ring, or acyclic hydrocarbon groups having 1 to 50 carbon atoms. Optionally, one or more carbon atoms of the hydrocarbon groups are substituted by one or more heteroatom linkers or heteroatom groups, as described above. Alternatively, or in addition, one or more hydrogen atoms of the hydrocarbon groups are substituted by one or more heteroatom groups. R⁴ in formula (5) is as described above. The subscripts q and r independently represent 0 or 1.

The hydrocarbon groups of R⁵ and R⁶ are optionally connected to form a silicon-containing ring. For example, the ring can include two to six ring carbon atoms. Some examples of silicon-containing rings resulting from the interconnection of the R⁵ and R⁶ groups of formula (5) include silacyclopropane, silacyclobutane, silacyclopentane, silacyclohexane, silacycloheptane, 2,2,-dimethylsilacyclopropane, 2,4 diethylsilacyclobutane, 2-methylenesilacyclobutane, and silacyclopent-2-ene rings.

In one embodiment, R⁵ and R⁶ are methyl groups. The methyl groups can be connected to form a silacyclopropane ring. In another embodiment, R¹ is an ethyl group and R⁶ is an isopropyl group. Depending on the carbon linkage chosen for interconnection, the ethyl and isopropyl groups can be connected to form, for example, a 1-methylsilacyclopentane ring or a 2,4-dimethylsilacyclobutane ring. In yet another embodiment, R⁵ is a vinyl group and R⁶ is an ethyl group. Depending on the carbon linkage chosen for interconnection, the groups can be connected to form, for example, a 2-methylenesilacyclobutane ring or a silacyclopent-2-ene ring.

In a further preferred embodiment to formula (5), the first group of siloxane patterning molecules are trialkoxysilanes represented by the formula:
R⁵Si(OR⁴)₃ (6)

In formula (6), R⁴ and R⁵ are as defined above in formula (5). In a further preferred embodiment, R⁵ is represented by the formula:
Yₐ—(CH₃₋ₐ)ₜ— (7)

In formula (7), a represents 0, or an integer from 1 to 3. More preferably, a is 1. Preferably, t represents an integer from 1 to 100. More preferably, t represents an integer from 1 to 50. More preferably, t represents an integer from 1 to 24. Even more preferably, t represents an integer from 1 to 10.

Yₐ in formula (7) represents one or more functional groups, or a suitable combination of functional groups. Some preferred functional groups include halo, —CH₃, silano (as described above), —OR⁷, —SR⁷, —SeR⁷, —TeR⁷, —S—SR⁷, —N(R⁷)₂, —N(R⁷)₃⁺, —N₃, —NO₂, —C(O)N(R⁷)₂, —C(O)R⁷, —C(O)O⁻, —C(O)OR⁷, —C(S)OR⁷, —NR⁷C(O)OR⁷, —NR⁷C(O)NR⁷, —NR⁷—N(R⁷)₂, —N═N(R⁷), ═N—N(R⁷)₂, —OCN, —NCO, —SCN, —NCS, —P(R⁷)₂, —P(OR⁷)₂, —As(R⁷)₂, —CN, —NC, —S(O)₂OH, —SO₃⁻, —P(O)(OH)₂, —PO₃²⁻, —C(O)—O—C(O)R⁷, —CR⁷═C(R⁷)₂, —C≡C—R⁷, maleimido, and biotinyl. In the examples given, R⁷ is as defined above.

In addition, R⁷ in —C(O)OR⁷ can be an ester-activating group. Some examples of ester-activating groups include 1-oxybenzotriazole, dicyclohexylcarbodiimide, and succinimide-N-oxy groups. Alternatively, the ester can be activated in an additional step with phosgene or thionylchloride to form the corresponding acyl chloride, or with carbonyldiimidazole to form an imidazolyl-linked carbonyl group.

In a further preferred embodiment of formula (7), Y represents —SH, —NH₂, or —CH═CH₂ wherein a is as defined in formula (7). In a further preferred embodiment, Yₐ represents —SH, —NH₂, or —CH═CH₂ and a is 1.

Some examples of suitable siloxane patterning molecules according to formula (6) and having such preferred groups for Y include 3-mercaptopropyltrimethoxy-silane, 3-mercaptopropyltriethoxysilane, 3-aminopropyltrimethoxysilane, 3-aminopropyltriethoxysilane, 18-nonadecenyltrimethoxysilane, 18-nonadecenyltriethoxysilane, allyltrimethoxysilane, allyltrimethoxysilane, allyltris(trimethylsiloxy)silane, 3-butenyltriethoxysilane, 21-docosenyltriethoxysilane, 10-undecenyltrimethoxysilane, vinyltriethoxysilane, vinyltrimethoxysilane, vinyltriisopropoxysilane, vinyltriisopropenoxysilane, vinyltriphenoxysilane, 7-octenyltrimethoxysilane, or any suitable combinations thereof.

Metal amides suitable as patterning molecules include any suitable metal ion, as described above, in combination with a suitable deprotonated amine. The deprotonated amine contains any of the substituted or unsubstituted hydrocarbon groups described above, including one or more silano groups, as described above, bound to a deprotonated amino group. Preferably, the hydrocarbon groups in the deprotonated amines are saturated or unsaturated; straight-chained or branched; cyclic or acyclic hydrocarbon groups having 1 to 6 carbon atoms.

Some examples of metal amides include the combination of metal ions with deprotonated versions of, for example, methylamine, dimethylamine, ethylamine, diethylamine, propylamine, dipropylamine, isopropylamine, butylamine, t-butylamine, silylamines, vinylamine, allylamine, phenylamine, and the like.

Some other suitable patterning molecules that can react with carboxylic acid or sulfonic acid groups of the oxidized substrate surface molecules, include, for example, the amine, phosphine, arsine, alcohol, and epoxide classes of molecules. Amine, phosphine, and arsine molecules are protonated by carboxylic acid and sulfonic acid groups to form the corresponding ammonium, phosphonium, or arsonium ionic complexes.

Amines suitable as patterning molecules include any of the hydrocarbon groups described above substituted with one or more nitrogen atoms. Such suitable amines include monoamines, diamines, triamines, and higher polyamines, such as amine-containing polymers.

Some examples of amines suitable as patterning molecules include methylamine, dimethylamine, ethylamine, diethylamine, allylamine, allylmethylamine, propylamine, dipropylamine, N,N-dimethyl-2-methyl-2-propenylamine, butylamine, butylmethylamine, pentylamine, hexylamine, octylamine, dodecylamine, hexadecylamine, octadecylamine, eicosylamine, docosylamine, triacontylamine, methylenediamine, ethylenediamine, propylenediamine, butylenediamine, pentylenediamine, hexylenediamine, heptylenediamine, octylenediamine, decylenediamine, diethylenetriamine, dipropylenetriamine, dibutylenetriamine, (4-bromophenyl)ethylamine, cyclopropylamine, cyclopropylmethylamine, cyclobutylamine, cyclopentylamine, N,N-dimethylcyclopentylamine, cyclohexylamine, 1,2-diaminocyclohexane, 1,4-diaminocyclohexane, N,N-dimethylcyclohexylamine, aniline, benzene-1,4-diamine, benzylamine, N,N,N′,N′-tetramethylbenzene-1,4-diamine, benzylethylamine, benzyldiethylamine, pyrrole, pyridine, pyrazole, pyrazine, pyrimidine, imidazole, triazine, 1,3,5-trimethyltriazine, 1,4-diazabicyclo[2.2.2]octane, 1,5-diazabicyclo[3.3.3]undecane, 1,4,7,10-tetraazacyclododecane (cyclen), 1,4,8,11 -tetraazacyclotetradecane (cyclam), 1,4,8,11-tetraazacyclotetradecane-5,7-dione (dioxocyclam), and the porphyrins.

Some examples of phosphines suitable as patterning molecules include triphenylphosphine, tris-(o-methylphenyl)phosphine, tris-(p-methylphenyl)phosphine, methyldiphenylphosphine, ethyldiphenylphosphine, diethylphenylphosphine, triethylphosphine, trihexylphosphine, and trioctylphosphine.

Some examples of arsines suitable as patterning molecules include triphenylarsine, methyldiphenylarsine, ethyldiphenylarsine, diethylphenylarsine, triethylarshine, trihexylarsine, and trioctylarsine.

Some examples of alcohols suitable as patterning molecules include methanol, ethanol, n-propanol, isopropanol, butanol, isobutanol, pentanol, decanol, dodecanol, ethylene glycol, propylene glycol, butylene glycol, cyclopentanol, cyclohexanol, phenol, allyl alcohol, propargyl alcohol, and the like. Under suitable conditions, such alcohols can be made to react with carboxylic acid or sulfonic acid groups to form carboxylic ester and sulfonic ester linkages. For example, the alcohols can be activated with alcohol-activating groups, such as carbonyldiimidazole, or be coupled with esterification catalysts.

Some examples of epoxides suitable as patterning molecules include glycidyl methyl ether, glycidyl isopropyl ether, glycidyl methacrylate, glycidyl 2,2,3,3,4,4,5,5,6,6,7,7,8,8,9,9-hexadecafluorononyl ether, glycidyl 4-methoxyphenyl ether, glycidyl 3-nitrobenzenesulfonate, diglycidyl ether of bisphenol A, epoxy phenol novolac resin, 3-glycidoxypropyldimethoxymethylsilane, 3-glycidoxypropyldimethylethoxysilane, 3-glycidoxypropyltrimethoxysilane, (glycidoxypropyldimethylsilyloxy) heptacyclopentylpentacyclooctasilane (i.e., glycidoxypropyldimethylsilyloxy-POSS), glycidylbutyrate, N,N-diglycidylaniline, diglycidyl 1,2-cyclohexanedicarboxylate, and glycidyl 4-nonylphenyl ether.

The first group of patterning molecules can additionally function as a substrate for one or more additional patterns on top of the first group of patterning molecules. For example, a second group of patterning molecules can be reacted with the first group of patterning molecules to make a two-layer pattern; a third group of patterning molecules can be reacted with the second group of patterning molecules to make a three-layer pattern; a fourth group of patterning molecules can be reacted with the third group of patterning molecules to make a four-layer pattern; and so on.

In one embodiment, a group of patterning molecules after the first group, i.e., a subsequent group of patterning molecules, reacts with a previous group of patterning molecules by reacting with an oxidized form of the previous group of patterning molecules.

To produce an oxidized form of a previous group of patterning molecules, the previous group of patterning molecules must contain oxidizable groups, as described above for the substrate surface molecules. The oxidizable groups in the previous group of patterning molecules are oxidized by the ultrafine tip in an additional oxidative step. In this case, the subsequent group of patterning molecules must contain groups which are capable of reacting with the oxidized form of the previous group of patterning molecules. Such reactive groups were described above for the first group of patterning molecules.

In another embodiment, a subsequent group of patterning molecules reacts with a previous group of patterning molecules by reacting with a non-oxidized form of the previous group of patterning molecules. In this case, since the previous group of patterning molecules do not undergo an additional oxidative step, they are not required to contain oxidizable groups.

However, in order to react with a subsequent group of patterning molecules to form an additional pattern, the previous group of non-oxidized patterning molecules must contain chemical groups which are reactive in some manner with the subsequent group of patterning molecules. For example, the previous group of non-oxidized patterning molecules can include accessible reactive groups. Some examples of reactive groups include phosphino, metal chelating, amino, cyano, cyanato, isocyanato, thioisocyanato, epoxy, halo, aldehydo, and anhydride groups.

In a preferred embodiment, non-oxidized patterning molecules containing such reactive groups are siloxane molecules. Some examples of such siloxane patterning molecules containing some of the reactive groups noted above include: 2-(diphenylphosphino)ethyltriethoxysilane, dicyclohexylphosphinoethyltriethoxysilane, dimethylphosphinoethyltrimethoxysilane, 2-aminopropyltriethoxysilane, 2-(ethylenediamine)ethyltriethoxysilane, 2-cyanoethyltrimethoxysilane, 16-cyanohexadecyltriethoxysilane, (2-aminoethoxy)dimethylpropylsilane, 3-glycidoxypropyltriethoxysilane, (18-glycidoxyoctadecyl)methydiethoxysilane, triethoxysilylbutyraldehyde, triethoxysilylundecanal, 3-(triethoxysilyl)propyl succinic anhydride, 3-iodopropyltrimethoxysilane, 3-bromopropyltrimethoxysilane, 11-bromoundecyl-trimethoxysilane, 2-chloroethylmethyldimethoxysilane, o-, m-, and p-chlorophenyltriethoxysilane, phenyltriethoxysilane, diphenyldiethoxysilane, methacryloxypropylmethyldiethoxysilane, 3-hydroxypropyltrimethoxysilane, 11-hydroxyundecyltrimethoxysilane, 3-isocyanatopropyltrimethoxysilane, 18-isocyanatooctadecyltriethoxysilane, 3-isothiocyanatopropyltrimethoxysilane, and 18-isothiocyanatooctadecyltriethoxysilane.

Some examples of subsequent patterning molecules which can react with some of the reactive siloxane patterning molecules described above include 1,2-(diphenylphosphino)ethane, 1,2-dibromoethane, 1,8-dibromooctane, phenylisocyanate, phenyldiisocyanate, diphenylmethanediisocyanate, hexamethylenediisocyanate, hexamethylenediamine, fumaric acid, succinic acid, malonic acid, terephthalic acid, citric acid, 1,2-ethanediol, 1,3-propanediol, 1,4-butanediol, and metal salts.

For example, 1,2-dibromoethane can react with a previous group of patterning molecules containing phosphino groups, such as dimethylphosphinoethyltrimethoxysilane, to form the corresponding ethylenephosphonium or ethylene-bridged diphosphonium ionic complexes. Or, for example, phenylisocyanate can react with a previous group of patterning molecules containing hydroxy or amino groups, such as 11-hydroxyundecyltrimethoxysilane or 2-aminopropyltriethoxysilane, to form the corresponding carbamate- or urea-bridged crosslinks.

Phosphorus-containing groups, sulfur-containing groups, and metal chelating groups are known to bind to metal atoms. Therefore, patterning molecules containing these groups may bind to either metal atoms or metal nanoparticles contained in a subsequent group of patterning molecules. The bound metal atoms may then function as a substrate for the further deposition of metal by, for example, any of the electroless and other metal deposition methods known in the art.

The patterning molecules can also contain fluorescent or biologically relevant groups. Some examples of fluorescent groups include fluorescein, rhodamine, and Texas Red. Some examples of reactive fluorescent molecules which may function as subsequent patterning molecules include the N-hydroxysuccimide (NHS)-activated fluorophores NHS-fluorescein and NHS-rhodamine; the isothiocyanate-activated fluorophores, such as isothiocyanate-fluorescein; and the sulfonyl chloride-activated fluorophores, such as Texas Red sulfonyl chloride.

Some examples of biologically relevant groups which may be used as subsequent patterning molecules include antibodies, enzymes, nucleotides, oligonucleotides, DNA, RNA, and biological binding agents. Some examples of antibodies include fluorescent-labeled, enzyme-labeled, and radio-labeled antibodies. An example of an enzyme includes horse radish peroxidase and its fluorophore-labeled derivatives. Some examples of biological binding agents include avidin, streptavidin, and biotin. Some examples of biotin-labeled molecules include NHS-biotin, maleimido-biotin, pyridyl disulfide biotin, amino-biotin, and hydrazido-biotin.

To produce the nanoscale patterns of the present invention, the first group of patterning molecules is present on the surface of the ultrafine tip during the writing process. However, the second, third, and higher subsequent groups of patterning molecules, when present, are not required to be deposited from the ultrafine tip. These subsequent groups of patterning molecules can be deposited by any appropriate means, including solution or vacuum deposition methods.

The method of the invention also includes techniques for imaging the patterned surface. Any suitable imaging technique can be used. Preferably, the imaging technique is a scanning probe imaging technique. Some examples of scanning probe imaging techniques include AFM and STM imaging techniques. The tip used for imaging can be the same or a different tip used for the patterning.

The invention also includes all of those embodiments which can be reasonably understood to be within the scope of the invention. In this regard, the invention includes any such adjustments or changes in the method which may improve such factors as writing speed, resolution, and so on.

For example, feature resolution depends on such factors as tip size, writing time, writing voltage, humidity, and temperature. Decreases in tip size, writing time, writing voltage, humidity, and temperature each independently decrease feature size. In addition, writing speed is dependent on voltage used. For example, by practicing the invention, a 150 nm wide line can be written using a speed of 10 μm/s. Faster speeds are possible by adjusting the above, and other, parameters. Other parameters include, for example, the concentration of patterning molecules on the tip, the chemical properties of the ink molecules, and the cleanliness of the tip.

Other modifications can be made to the invention to produce specialized or improved methods or resulting nanoscale patterns, all of which are within the scope of the invention. For example, in a modification of the process, the inventors have found a way to fabricate two different chemical patterns with the same ultrafine tip in situ. In particular, the inventors have found that an ultrafine tip which has been inked with a very dilute solution of patterning molecules possesses a very slow transfer rate of the patterning molecules to the substrate surface. Accordingly, when a voltage pulse and a single short scan is used, negligible transfer of patterning molecules occurs while the selected portion of the substrate surface is oxidized. Thus, an oxidized pattern of the substrate surface can be produced using such single short scans.

In contrast, when multiple scans are used with the same tip in situ, a layer of the patterning molecules is deposited. For example, after twenty minutes of scanning, a selected portion of the substrate surface is derivatized with the patterning molecules. By using the two procedures above, a pattern having an oxidized surface and a pattern derivatized with patterning molecules can be produced by the same tip in situ.

In another aspect, the invention is directed to a nanoscale patterned surface produced by any of the methods described above. Such a nanoscale patterned surface can be made to have any of the attributes considered above.

Examples have been set forth below for the purpose of illustration and to describe the best mode of the invention at the present time. However, the scope of this invention is not to be in any way limited by the examples set forth herein.

### EXAMPLES

### Example 1

### Preparation of a Substrate

An octadecyltrichlorosilane (OTS) film was prepared as follows. A silicon wafer was treated with piranha solution for 10 minutes. After drying the wafer under nitrogen, the wafer was soaked for approximately 24 hours in 5 mM OTS bicyclohexyl solution at 20° C. The wafer was then rinsed in chloroform for 30 seconds.

### Example 2

### Patterns Written on OTS Surface Using MPTMS Patterning Molecules

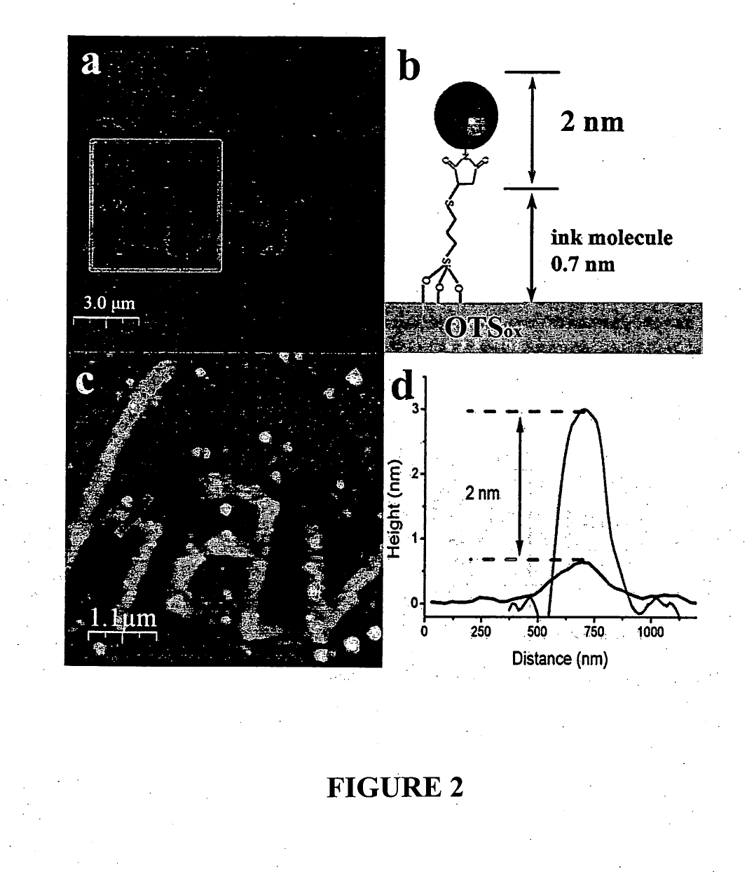

Shown in FIG. 2 is a pattern of mercaptopropyltrimethoxysilane (MPTMS) patterning molecules written on an OTS surface as prepared above using 9V and 5 μm/s speed (See FIG. 2a). The height of the pattern was measured to be 6.9±1.3 Å. To prove the identity of the pattern, a solution of 14 Å diameter gold nanoparticles was applied onto the patterned surface. The gold nanoparticles have a single monomaleimido linker which specifically links to mercapto groups. The overall particle size of the gold cluster including the maleimido linker is 18 Å. (See FIG. 2b). A zoom-in of the pattern after treating with the gold clusters is shown in FIG. 2c.

In FIG. 2d is shown height profiles of the pattern. The dark middle curve shows the height of the pattern before gold nanoparticle deposition, and was measured to be 6.9±1.3 Å. After the gold nanoparticle deposition, the height on the pattern increased as shown by the highest curve in FIG. 2d. The deposition adds approximately 19 Å in height, which is the approximate height of the gold nanoparticle.

### Example 3

### Multilayer Writing

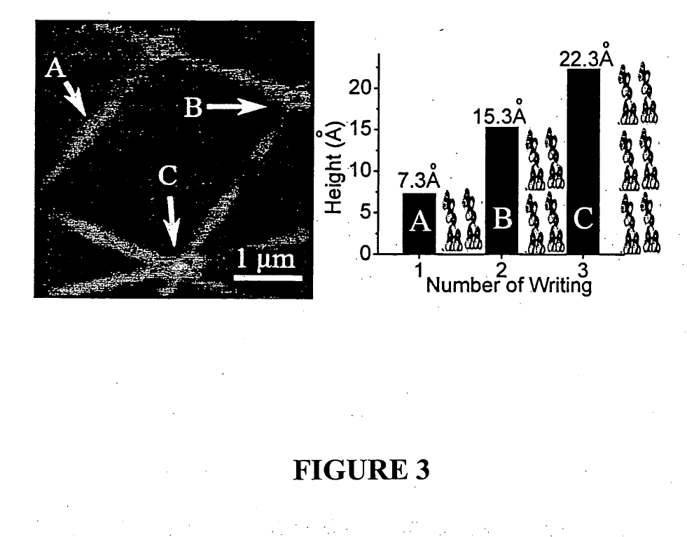

FIG. 3(a) shows a pattern that has several lines of MPTMS patterning molecules across each other written onto an OTS surface. The pattern has a scan area of 4216×4216 nm. Point A is a point on the MPTMS line. Point B is on an intersection of two MPTMS lines, i.e., where the tip wrote twice. Point C is on an intersection of three MPTMS lines, i.e., where the tip wrote three times. FIG. 3(b) shows the heights of point A, B and C. As shown, the heights of A, B and C closely correspond to the heights of one, two and three layers of MPTMS molecules. This fact indicates that each time the tip writes over the same location, it adds another layer of the ink.

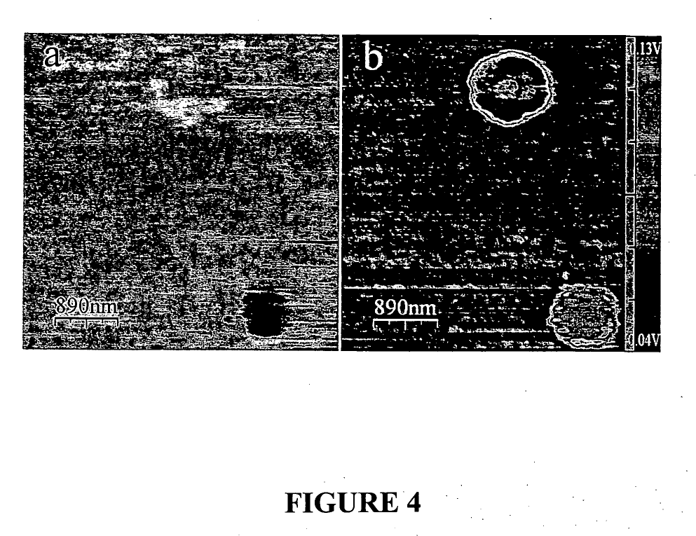

FIG. 4: Fabrication of a Patterned Surface with Two Different Chemistries

Shown in FIG. 4 are two spots having two different chemistries and fabricated with the same tip in situ. The upper spot, which is a pattern of MPTMS, was fabricated by writing with a tip coated with a very low concentration of MPTMS molecules, i.e., a 1:400 MPTMS solution. Due to the very low transfer rate of MPTMS at this concentration, twenty minutes of repetitive scanning was required to deposit the MPTMS layer in the upper spot.

The lower spot was fabricated by using the same tip in situ and giving a voltage pulse and a single rapid scan. Due to the short contact time, only a very minute portion of the MPTMS ink was delivered onto the reactive OTSox surface in the lower spot.

FIG. 4(a) shows a topographic image of the two spots. The upper spot shows positive contrast, indicating a second layer of MPTMS ink molecules is formed, while the lower spot shows negative contrast, indicating the exclusive presence of COOH groups on the surface.

FIG. 4(b) shows a friction image of the two spots. As shown in the image, the two spots show different frictional behaviors under the same imaging condition. This result further supports the fact that the two spots have different chemistries.

Thus, whereas there have been described what are presently believed to be the preferred embodiments of the present invention, those skilled in the art will realize that other and further embodiments can be made without departing from the spirit of the invention, and it is intended to include all such further modifications and changes as come within the true scope of the claims set forth herein.

1. A method for producing a nanoscale patterned surface, the method comprising:
providing an ultrafine tip having a first group of patterning molecules provided thereon;
providing a substrate surface having oxidizable groups accessible to said ultrafine tip;
contacting said ultrafine tip with a selected portion of said substrate surface;
positioning said ultrafine tip to be sufficiently proximal to said substrate surface in the presence of a liquid transporting medium to form a meniscus between said ultrafine tip and said substrate surface;
applying to the ultrafine tip a negative voltage capable of oxidizing said oxidizable groups to an oxidized form; whereby said substrate surface and said ultrafine tip are at least partially electrically conductive; and said first group of patterning molecules are capable of being hydrolyzed by, and/or capable of reacting with, said oxidized form, thereby producing a nanoscale surface patterned with said first group of patterning molecules.

2. The method according to claim 1, wherein said substrate surface is at least partially covered with substrate surface molecules, wherein at least a portion of said substrate surface molecules include methyl, vinyl, acetylenyl, or mercapto groups, or a combination thereof.

3. The method according to claim 2, wherein said substrate surface is at least partially covered with substrate surface molecules, wherein at least a portion of said substrate surface molecules are terminated with one or more methyl, vinyl, or acetylenyl groups, or a combination thereof.

4. The method according to claim 3, wherein the oxidized form is a carboxylic acid group.

5. The method according to claim 2, wherein said substrate surface is at least partially covered with substrate surface molecules, wherein at least a portion of said substrate surface molecules are terminated with one or more mercapto groups, and wherein the oxidized form is a sulfonic acid group.

6. The method according to claim 1, wherein said ultrafine tip is a scanning probe microscopy tip and has a surface comprising a metal, metal alloy, or semiconductor material.

7. The method according to claim 6, wherein said scanning probe microscopy tip has a surface comprising doped silicon, silicon nitride, tungsten, tungsten carbide, diamond-coated silicon, metal-coated silicon, or metal-coated silicon nitride.

8. The method according to claim 7, wherein said scanning probe microscopy tip has a surface comprising metal-coated silicon nitride.

9. The method according to claim 8, wherein the metal-coated silicon nitride is selected from platinum-coated silicon nitride, titanium-coated silicon nitride, copper-coated silicon nitride, or silver-coated silicon nitride.

10. The method according to claim 1, wherein said substrate surface is chemically the same, or different from, the bulk substrate.

11. The method according to claim 10, wherein said bulk substrate and/or substrate surface independently comprise a metal, metal alloy, metal oxide, metal sulfide, metal selenide, metal telluride, metal nitride, metal phosphide, metal arsenide, metal boride, metal carbide, metal silicide, metal salt, superconducting material, conducting polymer, or a combination thereof.

12. The method according to claim 11, wherein said bulk substrate and/or substrate surface independently comprise a metal, wherein said metal is selected from the group consisting of copper, nickel, aluminum, n- or p-doped silicon, gold, silver, palladium, platinum, rhodium, iridium, titanium, graphite, zinc, iron, beryllium, magnesium, or calcium.

13. The method according to claim 11, wherein said bulk substrate and/or substrate surface independently comprise a metal oxide, wherein said metal oxide is selected from the group consisting of n- or p-doped silicon oxide, mica, indium tin oxide, titanium oxide, iron oxide, copper oxide, yittrium oxide, zirconium oxide, thallium oxide, lithium oxide, magnesium oxide, calcium oxide, and aluminum oxide.

14. The method according to claim 13, wherein said substrate comprises n- or p-doped silicon and said substrate surface comprises n- or p-doped silicon oxide.

15. The method according to claim 11, wherein said bulk substrate and/or substrate surface independently comprises a metal sulfide, wherein said metal sulfide is selected from the group consisting of cadmium sulfide, gallium sulfide, iron sulfide, nickel sulfide, copper sulfide, lead sulfide, and zinc sulfide.

16. The method according to claim 11, wherein said bulk substrate and/or substrate surface independently comprises a metal selenide, wherein said metal selenide is selected from the group consisting of cadmium selenide, gallium selenide, copper selenide, and zinc selenide.

17. The method according to claim 11, wherein said bulk substrate and/or substrate surface independently comprise a metal nitride, wherein said metal nitride is selected from the group consisting of gallium nitride, indium nitride, aluminum nitride, and boron nitride.

18. The method according to claim 11, wherein said bulk substrate and/or substrate surface independently comprise a metal phosphide, wherein said metal phosphide is selected from the group consisting of gallium phosphide, indium phosphide, and zinc phosphide.

19. The method according to claim 11, wherein said bulk substrate and/or substrate surface independently comprise a metal arsenide, wherein said metal arsenide is selected from the group consisting of gallium arsenide, indium arsenide, and zinc arsenide.

20. The method according to claim 11, wherein said bulk substrate and/or substrate surface independently comprise a metal carbide, wherein said metal carbide is selected from the group consisting of tungsten carbide, silicon carbide, molybdenum carbide, titanium carbide, aluminum carbide, vanadium carbide, boron carbide, lithium carbide, barium carbide, calcium carbide, and tantalum carbide.

21. The method according to claim 11, wherein said bulk substrate and/or substrate surface independently comprise a metal salt, wherein said metal salt is comprising one or more alkali or alkaline earth metal ions in combination with one or more counteranions selected from the group consisting of halide, sulfate, nitrate, phosphate, carboxylate, borate, carbonate, silicate, selenoate, and arsenate.

22. The method according to claim 11, wherein said bulk substrate and/or substrate surface independently comprise a conducting polymer, wherein said conducting polymer is selected from the group consisting of polyaniline, polypyrrole, polythiophene, poly(para-phenylene), poly(p-phenylenevinylene), polyacetylene, and combinations thereof, chemical derivatives thereof, and doped derivatives thereof.

23. The method according to claim 2, wherein at least a portion of said substrate surface molecules are independently saturated or unsaturated; straight-chained or branched; cyclic, polycyclic, fused ring, or acyclic hydrocarbon molecules having 1 to 50 carbon atoms, wherein optionally, one or more carbon atoms of said hydrocarbon molecules are substituted by one or more heteroatom linkers or heteroatom groups, and/or one or more hydrogen atoms of said hydrocarbon molecules are substituted by one or more heteroatom groups.

24. The method according to claim 23, wherein at least a portion of said hydrocarbon molecules are substituted by one or more silano groups.

25. The method according to claim 24, wherein said one or more silano groups are independently selected from the group consisting of —Si(R⁷)₃, —Si(R⁷)₂—, —Si(R⁷)═, —Si≡, —SiCl₃, —SiCl₂—, —SiCl═, —Si(O—)₃, —Si(O—)₂—, —Si(O—)═, —Si(OR⁷)₃, —SiR⁷(OR⁷)₂, and —Si(R⁷)₂(OR⁷); wherein:
the symbols ═ and ≡ represent two and three separate single bonds, respectively, wherein each single bond is between a silicon atom and a carbon atom or suitable heteroatom; and R⁷ independently represents H; or a saturated or unsaturated; straight-chained or branched; cyclic or acyclic hydrocarbon group having 1 to 6 carbon atoms.

26. The method according to claim 25, wherein at least a portion of said substrate surface molecules are surface siloxane molecules represented by the formula:
R¹ₙR²ₘR³ₚSi(OR⁴)₄₋ₘ₋ₙ₋ₚ (1); wherein:
R¹, R², and R³ independently represent H; or saturated or unsaturated; straight-chained or branched; cyclic, polycyclic, fused ring, or acyclic hydrocarbon groups having 1 to 50 carbon atoms, wherein optionally, one or more carbon atoms of said hydrocarbon groups are substituted by one or more heteroatom linkers or heteroatom groups, and/or one or more hydrogen atoms of said hydrocarbon groups are substituted by one or more heteroatom groups;
R⁴ independently represents H; or a saturated or unsaturated; straight-chained or branched; cyclic or acyclic hydrocarbon group having 1 to 6 carbon atoms; or a silano group;
at least a portion of said hydrocarbon groups of R¹, R², and R³ are terminated with methyl, vinyl, acetylenyl, or mercapto groups, or a combination thereof; and
m, n, and p independently represent 0 or 1, provided that at least one of m, n, and p is 1 and at least one of R¹, R², and R³ represents the hydrocarbon groups of R¹, R², and R³; or, when m, n, and p are all 0, then R⁴ represents the hydrocarbon groups of R⁴, wherein at least a portion of said hydrocarbon groups of R⁴ are terminated with methyl, vinyl, acetylenyl, or mercapto groups, or a combination thereof.

27. The method according to claim 26, wherein the OR⁴ groups in formula (1) are hydrolyzed in the presence of surface-adsorbed water to form crosslinked surface siloxane molecules having silicon-oxide-silicon bonds between said surface siloxane molecules and/or silicon-oxide-metal bonds between surface siloxane molecules and a metal oxide surface, wherein said metal is a metal of said metal oxide surface.

28. The method according to claim 27, wherein said crosslinked surface siloxane molecules are formed by surface-mediated hydrolysis of chlorosilane precursors of the formula
R¹ₙR²ₘR³ₚSiCl₄₋ₘ₋ₙ₋ₚ (2); wherein:
R¹, R², and R³ independently represent H; or saturated or unsaturated; straight-chained or branched; cyclic, polycyclic, fused ring, or acyclic hydrocarbon groups having 1 to 50 carbon atoms, wherein optionally, one or more carbon atoms of said hydrocarbon groups are substituted by one or more heteroatom linkers or heteroatom groups, and/or one or more hydrogen atoms of said hydrocarbon groups are substituted by one or more heteroatom groups;
at least a portion of said hydrocarbon groups are terminated with methyl, vinyl, acetylenyl, or mercapto groups, or a combination thereof; and
m, n, and p independently represent 0 or 1, provided that at least one of m, n, and p is not 0, and at least one of R¹, R², and R³ is not H.

29. The method according to claim 26, wherein said surface siloxane molecules are represented by the formula:
R¹Si(OR⁴)₃ (3);
wherein R¹ represents a saturated or unsaturated; straight-chained or branched; cyclic, polycyclic, fused ring, or acyclic hydrocarbon group having 1 to 50 carbon atoms; and R⁴ independently represents H; or a saturated or unsaturated; straight-chained or branched; cyclic or acyclic hydrocarbon group having 1 to 6 carbon atoms; or a silano group.

30. The method according to claim 29, wherein the OR⁴ groups in formula (3) are hydrolyzed in the presence of surface-adsorbed water to form crosslinked surface siloxane molecules having silicon-oxide-silicon bonds between said surface siloxane molecules and/or silicon-oxide-metal bonds between surface siloxane molecules and a metal oxide surface, wherein said metal is a metal of said metal oxide surface.

31. The method according to claim 30, wherein said crosslinked surface siloxane molecules are formed by surface-mediated hydrolysis of trichlorosilane precursors of the formula
R¹SiCl₃ (4);
wherein R¹ represents a saturated or unsaturated; straight-chained or branched; cyclic, polycyclic, fused ring, or acyclic hydrocarbon group having 1 to 50 carbon atoms.

32. The method according to claim 29 or 31, wherein R¹ is represented by the formula CH₃(CH₂)ₛ—, wherein s represents 0, or an integer from 1 to 30.

33. The method according to claim 32, wherein s represents an integer from 10 to 20.

34. The method according to claim 33, wherein s is 17.

35. The method according to claim 31, wherein at least a portion of trichlorosilane precursors are selected from the group consisting of methyltrichlorosilane, ethyltrichlorosilane, n-propyltrichlorosilane, iso-propyltrichlorosilane, n-butyltrichlorosilane, iso-butyltrichlorosilane, t-butyltrichlorosilane, n-pentyltrichlorosilane, n-hexyltrichlorosilane, n-heptyltrichlorosilane, n-octyltrichlorosilane, n-nonyltrichlorosilane, n-decyltrichlorosilane, n-undecyltrichlorosilane, n-hexadecyltrichlorosilane, n-octadecyltrichlorosilane, n-docosyltrichlorosilane, n-triacontyltrichlorsilane, 18-nonadecenyltrichlorosilane, (3-acryloxypropyl)-trichlorosilane, allyltrichlorosilane, 3-butenyltrichlorosilane, methacryloxypropyltrichlorosilane, 7-octenyltrichlorosilane, 10-undecenyltrichlorosilane, and vinyltrichlorosilane.

36. The method according to claim 1, wherein said substrate surface molecules are capable of forming a positive interaction with the substrate surface and/or intermolecular bonds between said substrate surface molecules, wherein said bonds are independently covalent or non-covalent bonds, thereby forming an ordered molecular monolayer of said substrate surface molecules on said substrate surface.

37. The method according to claim 36, wherein said substrate surface molecules form a self-assembled monolayer on said substrate surface.

38. The method according to claim 1, wherein at least a portion of said first group of patterning molecules are selected from the group consisting of metal alkoxide, metal amide, amino, phosphino, arsino, alcohol, and epoxide classes of molecules.

39. The method according to claim 38, wherein said first group of patterning molecules comprise one or a suitable combination of metal alkoxides.

40. The method according to claim 39, wherein said metal alkoxides are alkoxides of one or a suitable combination of alkaline earth, transition metal, main group metal, lanthanide, or actinide classes of metals.

41. The method according to claim 40, wherein said metal alkoxides are alkoxides of the main group metals.

42. The method according to claim 41, wherein said main group metal is silicon, thereby resulting in siloxane patterning molecules.

43. The method according to claim 41, wherein said siloxane patterning molecules are represented by the formula
R⁵_{q}R⁶ᵣSi(OR⁴)_{4-q-r} (5); wherein:
R⁵ and R⁶ independently represent H; halo; or saturated or unsaturated; straight-chained or branched; cyclic, polycyclic, fused ring, or acyclic hydrocarbon groups having 1 to 50 carbon atoms, wherein optionally, one or more carbon atoms of said hydrocarbon groups are substituted by one or more heteroatom linkers or heteroatom groups, and/or one or more hydrogen atoms of said hydrocarbon groups are substituted by one or more heteroatom groups;
R⁴ independently represents H; or a saturated or unsaturated; straight-chained or branched; cyclic or acyclic hydrocarbon group having 1 to 6 carbon atoms; or a silano group;
the hydrocarbon groups of R⁵ and R⁶ are optionally connected to form a ring comprising three to six ring carbon atoms; and
q and r independently represent 0 or 1.

44. The method according to claim 43, wherein at least a portion of said siloxane patterning molecules are represented by the formula
R⁵Si(OR⁴)₃ (6);
wherein R⁵ represents a saturated or unsaturated; straight-chained or branched; cyclic, polycyclic, fused ring, or acyclic hydrocarbon group having 1 to 50 carbon atoms, wherein optionally, one or more carbon atoms of said hydrocarbon group are substituted by one or more heteroatom linkers or heteroatom groups, and/or one or more hydrogen atoms of said hydrocarbon group are substituted by one or more heteroatom groups; and
R⁴ independently represents H; a saturated or unsaturated; straight-chained or branched;
cyclic or acyclic hydrocarbon group having 1 to 6 carbon atoms; or a silano group.

45. The method according to claim 44, wherein R⁵ is represented by the formula Yₐ—(CH₃₋ₐ)ₜ—, wherein Yₐ represents one or more functional groups; a represents 0, or an integer from 1 to 3; and t represents an integer from 1 to 50.

46. The method according to claim 45, wherein Yₐ represents one or more functional groups independently selected from the group consisting of halo, —CH₃, silano, —OR⁷, —SR⁷, —SeR⁷, —TeR⁷, —S—SR⁷, —N(R⁷)₂, —N(R⁷)₃+, —N₃, —NO₂, —C(O)N(R⁷)₂, —C(O)R⁷, —C(O)O⁻, —C(O)OR⁷, —C(S)OR⁷, —NR⁷C(O)OR⁷, —NR⁷C(O)NR⁷, —NR⁷—N(R⁷)₂, —N═N(R⁷), ═N—N(R⁷)₂, —OCN, —NCO, —SCN, —NCS, —P(R⁷)₂, —P(OR⁷)₂, —As(R⁷)₂, —CN, —NC, —S(O)₂OH, —SO₃⁻, —P(O)(OH)₂, —PO₃²⁻, —C(O)—O—C(O)R⁷, —CR⁷═C(R⁷)₂, —C≡C—R⁷, maleimido, and biotinyl;
R⁷ independently represents H; or a saturated or unsaturated; straight-chained or branched; cyclic or acyclic hydrocarbon group having 1 to 6 carbon atoms; and optionally, R⁷ in —C(O)OR⁷ is an ester-activating group.

47. The method according to claim 45, wherein Yₐ represents —SH and a is 1.

48. The method according to claim 47, wherein t represents an integer from 1 to 24.

49. The method according to claim 48, wherein t represents an integer from 1 to 10.

50. The method according to claim 49, wherein at least a portion of said siloxane patterning molecules are selected from 3-mercaptopropyltrimethoxysilane, 3-mercaptopropyltriethoxysilane, or a combination thereof.

51. The method according to claim 45, wherein Yₐ represents —NH₂ and a is 1.

52. The method according to claim 51, wherein t represents an integer from 1 to 24.

53. The method according to claim 52, wherein t represents an integer from 1 to 10.

54. The method according to claim 53, wherein said siloxane patterning molecules are selected from 3-aminopropyltrimethoxysilane, 3-aminopropyltriethoxysilane, or a combination thereof.

55. The method according to claim 45, wherein Yₐ represents —CH═CH₂ and a is 1.

56. The method according to claim 55, wherein t represents an integer from 1 to 24.

57. The method according to claim 56, wherein said siloxane patterning molecules are selected from 18-nonadecenyltrimethoxysilane, 18 -nonadecenyltriethoxysilane, allyltrimethoxysilane, allyltrimethoxysilane, allyltris(trimethylsiloxy)silane, 3-butenyltriethoxysilane, 21-docosenyltriethoxysilane, 10-undecenyltrimethoxysilane, vinyltriethoxysilane, vinyltrimethoxysilane, vinyltriisopropoxysilane, vinyltriisopropenoxysilane, vinyltriphenoxysilane, 7-octenyltrimethoxysilane, or any suitable combination thereof.

58. The method according to claim 1, wherein said negative voltage bias is a minimum of approximately 5 volts

59. The method according to claim 58, wherein said negative voltage bias is a maximum of approximately 15 volts.

60. The method according to claim 1, wherein said liquid transporting medium is an aqueous transporting medium.

61. The method according to claim 60, wherein said aqueous transporting medium results from performing at least some portion of the method under conditions of non-zero humidity.

62. The method according to claim 61, wherein said humidity is a minimum of about fifty percent to a maximum of about one hundred percent.

63. The method according to claim 62, wherein said humidity is approximately one hundred percent.

64. The method according to claim 1, wherein said liquid transporting medium comprises water.

65. The method according to claim 64, wherein said liquid transporting medium comprises a mixture of a non-aqueous solvent and water.

66. The method according to claim 65, wherein said water is in a trace amount.

67. The method according to claim 1, further comprising imaging said patterned surface.

68. The method according to claim 67, wherein said imaging is by a scanning probe microscopy imaging technique.

69. The method according to claim 68, wherein said scanning probe microscopy imaging technique uses said scanning probe microscopy tip used for producing said patterned surface.

70. The method according to claim 1, further comprising producing one or more additional patterns on top of said first group of patterning molecules on said patterned surface, the method further comprising:
contacting an ultrafine tip having a second group of patterning molecules provided thereon with a selected portion of a substrate surface having a first group of patterning molecules having oxidizable groups accessible to said ultrafine tip;
positioning said ultrafine tip to be sufficiently proximal to said substrate surface in the presence of a liquid transporting medium to form a meniscus between said ultrafine tip and said substrate surface;
applying to the ultrafine tip a negative voltage capable of oxidizing said oxidizable groups to an oxidized form;
whereby said second group of patterning molecules are capable of being hydrolyzed by, and/or capable of reacting with, said oxidized form, thereby producing a surface patterned with said second group of patterning molecules; and
optionally, repeating said method with any number of subsequent groups of patterning molecules to produce a surface patterned with said number of subsequent groups of patterning molecules.

71. A method for producing a nanoscale patterned surface, the method comprising:
providing an ultrafine tip having a first group of siloxane patterning molecules provided thereon;
providing a silicon oxide surface at least partially covered with siloxane molecules terminated with methyl, vinyl, acetylenyl, or mercapto groups, or a combination thereof;
contacting said ultrafine tip with a selected portion of said silicon oxide surface;
positioning said ultrafine tip to be sufficiently proximal to said silicon oxide surface in the presence of a liquid transporting medium to form a meniscus between said ultrafine tip and said silicon oxide surface;
applying to the ultrafine tip a negative voltage capable of oxidizing said methyl, vinyl, acetylenyl, or mercapto groups to an oxidized form; whereby said silicon oxide surface and said ultrafine tip are at least partially electrically conductive; and said first group of siloxane patterning molecules are capable of being hydrolyzed by, and/or capable of reacting with, said oxidized form, thereby producing a nanoscale surface patterned with said first group of siloxane patterning molecules.

72. A nanoscale patterned surface produced by a method comprising:
providing an ultrafine tip having a first group of patterning molecules provided thereon;
providing a substrate surface having oxidizable groups accessible to said ultrafine tip;
contacting said ultrafine tip with a selected portion of said substrate surface;
positioning said ultrafine tip to be sufficiently proximal to said substrate surface in the presence of a liquid transporting medium to form a meniscus between said ultrafine tip and said substrate surface;
applying to the ultrafine tip a negative voltage capable of oxidizing said oxidizable groups to an oxidized form; whereby said substrate surface and said ultrafine tip are at least partially electrically conductive; and said first group of patterning molecules are capable of being hydrolyzed by, and/or capable of reacting with, said oxidized form.

73. A silicon oxide nanoscale patterned surface produced by a method comprising
providing an ultrafine tip having a first group of siloxane patterning molecules provided thereon;
providing a silicon oxide surface at least partially covered with siloxane molecules terminated with methyl, vinyl, acetylenyl, or mercapto groups, or a combination thereof;
contacting said ultrafine tip with a selected portion of said silicon oxide surface;
positioning said ultrafine tip to be sufficiently proximal to said silicon oxide surface in the presence of a liquid transporting medium to form a meniscus between said ultrafine tip and said silicon oxide surface;
applying to the ultrafine tip a negative voltage capable of oxidizing said methyl, vinyl, acetylenyl, or mercapto groups to an oxidized form; whereby said silicon oxide surface and said ultrafine tip are at least partially electrically conductive; and said first group of siloxane patterning molecules are capable of being hydrolyzed by, and/or capable of reacting with, said oxidized form.
